(19) United States
(12) Patent Application Publication
(10) Pub. No.: US 2026/0330061 A1
(43) Pub. Date: Oct. 22, 2026

(54) SYSTEM AND METHOD FOR AI-ENHANCED TRUSTLESS POSITIVE IDENTIFICATION WITH PRIVACY PROTECTION AND BLOCKCHAIN TECHNOLOGY

(71) Applicant: STEALTH COMPANY SRL START UP INNOVATIVA, Rome (IT)

(72) Inventors: Antonio ROSSI, Rome (IT); Edoardo ROSSI, Rome (IT)

(21) Appl. No.: 19/710,239

(22) Filed: Jun. 16, 2026

(30) Foreign Application Priority Data
Jun. 20, 2025 (IT) 102025000014764

(51) Int. Cl. G06F 21/62; H04L 9/32

(52) U.S. Cl. CPC G06F 21/6254; H04L 9/3218; H04L 9/3231

(57) ABSTRACT

A positive identification system authenticates an identity of a user from a plurality of biometric modalities using context-aware modality selection, continuous liveness detection, and dynamic risk adaptation, and generates a zero-knowledge proof of the identity without exposing raw biometric data. A multimodal artificial-intelligence engine detects personally identifiable information in data associated with the user by simultaneously processing text and images, and an anonymization module removes the personally identifiable information while preserving data utility to produce anonymized data. The system generates an attestation of the identity based on the zero-knowledge proof, anchors the attestation on a distributed ledger, and records a commit value generated from a master hash of an ensemble that includes the anonymized data and a user-controlled secret, such that the raw biometric data and the personally identifiable information are not exposed on the distributed ledger.

### CROSS-REFERENCE TO RELATED APPLICATIONS

This application claims priority to Italian Patent Application No. 102025000014764, filed Jun. 20, 2025, the entire contents of which are incorporated herein by reference.

### FIELD OF THE DISCLOSURE

Embodiments of the present disclosure relate generally to digital identity management systems. More specifically, it concerns systems and methods for trustless positive identification, incorporating multimodal biometrics, artificial intelligence for privacy protection, privacy-preserving computation, robust management of data sets, and blockchain-agnostic infrastructure to enhance security, user control, and data privacy.

### BACKGROUND

The present disclosure relates generally to digital identity, and more particularly to systems and methods for positive identification of a user that authenticate an identity from biometric data, generate cryptographic proofs of identity, detect and anonymize personally identifiable information, and record verifiable representations of data on a distributed ledger.

Systems for digital identity may employ biometric authentication, privacy-preserving computation, anonymization of personally identifiable information, and distributed-ledger technologies. The design of such systems involves balancing competing objectives, including the security and accuracy of authentication, the privacy of biometric and personal data, the utility of data that has been processed to protect privacy, and the integrity and provenance of stored data.

It is in this context that embodiments of the present disclosure are provided.

### SUMMARY

Embodiments of the present disclosure provide a comprehensive trustless positive identification (referred to as TPI) system and associated method, designed to address the limitations in existing digital identity management solutions. The primary object of the present disclosure is to improve user security, privacy, and control over personal identity data, while ensuring robust interoperability and verifiability in a decentralized manner.

In one aspect, a positive identification system comprises one or more hardware processors; one or more biometric sensors configured to capture raw biometric data of a user; and one or more memories storing instructions that, when executed by the one or more hardware processors, implement a multimodal biometric authentication system and an artificial-intelligence-based personally identifiable information (PII) removal system. The multimodal biometric authentication system comprises a context-aware modality selection module that dynamically selects, combines, and weights a plurality of biometric modalities based on at least one of a transaction risk level, an environmental condition, or a user preference; a continuous liveness detection module that detects a spoofing attempt in real time by analyzing one or more time-varying characteristics of the raw biometric data over a course of the biometric authentication; a dynamic risk assessment engine that adapts one or more authentication requirements by providing one or more risk inputs to the context-aware modality selection module for a subsequent biometric capture; and a zero-knowledge proof generator that generates a zero-knowledge proof of the identity of the user without exposing the raw biometric data. The artificial-intelligence-based PII removal system comprises a multimodal PII detection engine comprising one or more multimodal artificial-intelligence models that detect PII in data associated with the user by simultaneously processing text and images using one or more transformer architectures, the multimodal PII detection engine further comprising a cross-modal reasoning module that correlates textual mentions with visual appearances across documents; a context-aware detection module that uses one or more attention mechanisms to distinguish between benign terms and actual PII; and an intelligent anonymization module that anonymizes the detected PII while preserving data utility to produce anonymized data. The instructions further cause the system to generate an attestation of the identity based on at least the zero-knowledge proof, anchor the attestation on a distributed ledger, generate a commit value by cryptographically hashing a combination of a master hash and a user-controlled secret, the master hash being generated from individual cryptographic hashes of data components of an ensemble that includes the anonymized data and the combination constituting a reveal value that is kept hidden from the distributed ledger, and record the commit value on the distributed ledger, such that the raw biometric data and the PII are not exposed on the distributed ledger.

In another aspect, a method for positive identification of a user, performed by a computing system comprising one or more hardware processors, comprises authenticating an identity of the user from a plurality of biometric modalities captured via one or more biometric sensors, including dynamically selecting, combining, and weighting the plurality of biometric modalities based on at least one of a transaction risk level, an environmental condition, or a user preference, performing real-time anti-spoofing liveness detection on biometric data captured during the authenticating, and adapting one or more authentication requirements based on contextual and behavioral factors; generating a zero-knowledge proof of the identity without exposing raw biometric data; detecting PII in data associated with the user using one or more multimodal artificial-intelligence models that simultaneously process text and images using one or more transformer architectures, including assigning a confidence score to each detected instance of the PII and using one or more attention mechanisms to distinguish between benign terms and actual PII; anonymizing, based on the assigned confidence scores, at least a subset of the detected instances while preserving data utility to produce anonymized data; verifying quality of the anonymized data, including a re-identification risk assessment; generating, based on at least the zero-knowledge proof, an attestation of the identity; anchoring the attestation on a distributed ledger; generating a commit value by cryptographically hashing a combination of a master hash and a user-controlled secret, the master hash being generated from individual cryptographic hashes of data components of an ensemble that includes the anonymized data and the combination constituting a reveal value that is kept hidden from the distributed ledger; and recording the commit value on the distributed ledger, wherein the raw biometric data and the PII are not exposed on the distributed ledger.

In a further aspect, a non-transitory computer-readable medium stores instructions that, when executed by one or more hardware processors of a computing system, cause the computing system to perform operations comprising receiving, from a user device, a zero-knowledge proof of an identity of a user, the zero-knowledge proof having been generated at the user device without exposing raw biometric data of the user in connection with a biometric authentication performed at the user device using a plurality of biometric modalities dynamically selected, combined, and weighted based on at least one of a transaction risk level, an environmental condition, or a user preference and including real-time anti-spoofing liveness detection; verifying the zero-knowledge proof; detecting PII in data associated with the user using one or more multimodal artificial-intelligence models that simultaneously process text and images using one or more transformer architectures, including correlating textual mentions with visual appearances across documents and using one or more attention mechanisms to distinguish between benign terms and actual PII; anonymizing the detected PII while preserving data utility to produce anonymized data; verifying quality of the anonymized data, including a re-identification risk assessment; generating, based on at least the verified zero-knowledge proof, an attestation of the identity; anchoring the attestation on a distributed ledger; generating a commit value by cryptographically hashing a combination of a master hash of an ensemble that includes the anonymized data and a user-controlled secret, the combination constituting a reveal value that is kept hidden from the distributed ledger; and recording the commit value on the distributed ledger, wherein the raw biometric data and the PII are not exposed on the distributed ledger.

Through the synergistic operation of these components, embodiments of the present disclosure preserve the privacy of biometric-authentication data and of personally identifiable information without sacrificing the accuracy of recognition or the utility of processed data, by retaining raw biometric data on the user device, exposing only zero-knowledge proofs and privacy-preserving representations such as hashes, commit values, and attestations to a distributed ledger, and anonymizing personally identifiable information while preserving data utility. These and other objects and advantages of the present disclosure will become more apparent from the following detailed description and the accompanying drawings.

### BRIEF DESCRIPTION OF THE DRAWINGS

Embodiments of the present disclosure are described with reference to the accompanying drawings, in which:

FIG. 1 is a block diagram of the trustless positive identification system.

FIG. 2 is a block diagram of the artificial-intelligence-based personally identifiable information removal system.

FIG. 3 is a block diagram of the privacy-preserving computation engine.

FIG. 4 is a flow diagram of an adaptive authentication process of the biometric wallet.

FIG. 5 is a block diagram of the provably robust ensemble management system.

FIG. 6 is a block diagram of the data custodian interface.

FIG. 7 is a block diagram of the blockchain-agnostic infrastructure.

FIG. 8 is a block diagram of the enhanced ensemble management system.

FIG. 9 is a block diagram of an exemplary computing environment.

FIG. 10 is a block diagram of an ensemble identifier system.

FIG. 11 is a flow diagram of a method for positive identification of a user.

### DETAILED DESCRIPTION

It will be immediately obvious that countless variations and modifications may be made to what is described, for example relating to shape, dimensions, arrangements, and parts with equivalent functionality, without departing from the scope of protection of the present disclosure as set forth in the appended claims.

Embodiments of the present disclosure are directed to a TPI (Trustless Positive Identification) system and its various components, designed to provide greater security, privacy and user control over personal identity data. The following description provides details on preferred embodiments and operational aspects of the present disclosure, enabling a POSITA (Person Ordinarily Skilled In The Art) to make and use the present disclosure.

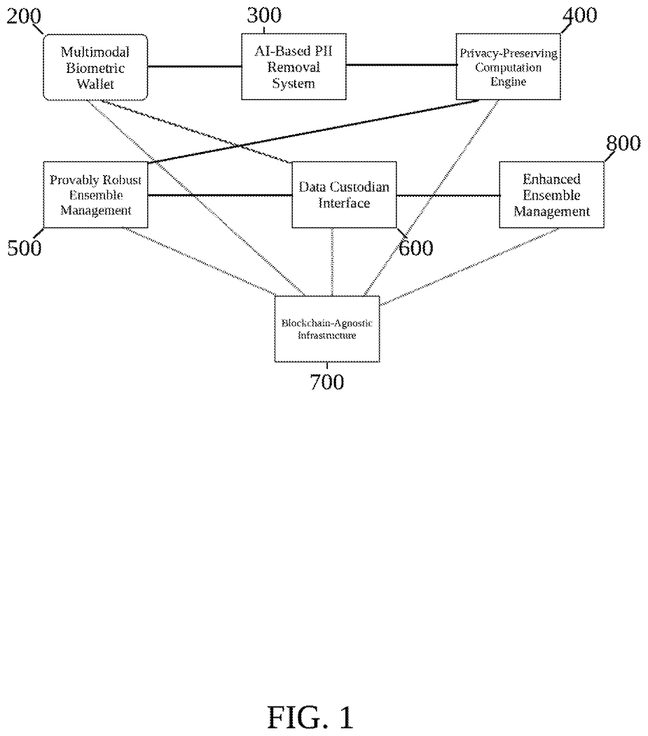

Referring to FIG. 1, the trustless positive identification system includes the multimodal biometric wallet 200, the artificial-intelligence-based PII removal system 300, the privacy-preserving computation engine 400, the provably robust ensemble management system 500, the data custodian interface 600, the blockchain-agnostic infrastructure 700, and the enhanced ensemble management system 800. In FIG. 1, solid lines represent system connections, dashed lines represent privacy-preserving data flows, and dotted lines represent blockchain connections.

### Exemplary Computing Environment

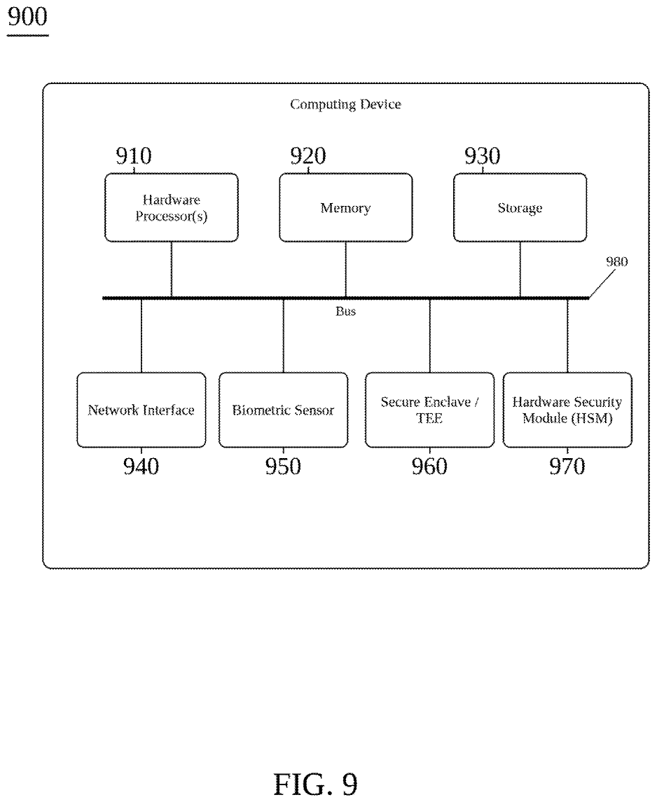

The components and methods described herein may be implemented on one or more computing devices. With reference to FIG. 9, an exemplary computing environment includes a computing device 900 having one or more hardware processors 910, a memory 920, and non-transitory storage 930 storing instructions that, when executed by the one or more hardware processors 910, cause the computing device 900 to perform the operations described herein. The computing device 900 may further include a network interface 940 for communicating over one or more networks, one or more biometric sensors 950 for capturing biometric data, a hardware-based secure enclave or trusted execution environment (TEE) 960 for processing sensitive data and models in isolation from a host operating system, and a hardware security module (HSM) 970 for managing cryptographic keys, which may be interconnected by a bus 980. The engines, modules, and systems described herein may be implemented as software executed by the one or more hardware processors 910, as dedicated hardware, or as a combination thereof, and may be distributed across a plurality of such computing devices in communication over a network.

### Implementation of the Components

The components described herein may be implemented as hardware, as software executed by one or more hardware processors, or as a combination of hardware and software, according to an embodiment of the present disclosure.

For example, the multimodal biometric wallet 200 may be implemented as software, such as a mobile or desktop application, that operates in cooperation with hardware components such as a biometric sensor and a hardware-based secure enclave. The artificial-intelligence-based PII removal system 300 and the privacy-preserving computation engine 400 may be implemented as software, such as machine-learning models and cryptographic libraries, executed by one or more hardware processors, graphics processing units, or trusted execution environments. The provably robust ensemble management system 500, the data custodian interface 600, and the enhanced ensemble management system 800 may be implemented as software, such as services, application programming interfaces, and smart contracts executed by one or more hardware processors. The blockchain-agnostic infrastructure 700 may be implemented as software, such as protocol adapters and abstraction layers, that cooperates with hardware components such as a hardware security module for key management. Components that capture, store, or protect data, such as a biometric sensor, a memory, a secure enclave, and a hardware security module, are implemented as hardware.

### Definitions

The following terms and acronyms are used in this detailed description:

AI (Artificial Intelligence): Computer systems capable of performing tasks that normally require human intelligence, such as visual perception, speech recognition, decision-making, and language translation. Examples of AI systems include machine-learning models, deep neural networks, convolutional neural networks, transformer-based models, large language models, vision-language models, generative adversarial networks, variational autoencoders, and reinforcement-learning agents.

BAI (Blockchain-Agnostic Infrastructure) 700: A component of the present disclosure configured to provide a flexible and interoperable interface to various blockchains and Distributed Ledger Technologies (DLTs), avoiding lock-in to a single platform.

BAL (Blockchain Abstraction Layer): A subcomponent of the BAI 700 that provides a universal API for interacting with different DLTs.

Biometric Data: Physiological or behavioral characteristics used to identify individuals, such as fingerprints, facial features, iris patterns, voice, or typing dynamics.

Differential Privacy (DP): A system for publicly sharing information about a dataset by describing the patterns of groups within the dataset, while concealing information about individuals in the dataset. It provides mathematical privacy guarantees.

DLT (Distributed Ledger Technology): A digital system for recording asset transactions in which transactions and their details are recorded in multiple locations simultaneously. Blockchain is a common type of DLT. Examples of blockchain and DLT systems include Ethereum, Hyperledger Fabric, Polkadot, Bitcoin, and Solana, which may be implemented as public or permissioned ledgers.

Ethereum, Hyperledger Fabric, Polkadot, Bitcoin, Solana, and BitTorrent are trademarks or trade names of their respective owners and are used herein solely as non-limiting examples of distributed-ledger and related technologies.

EDCI (Enhanced Data Custodian Interface) 600: A component of the present disclosure that enables organizations (data custodians) to perform analyses and derive insights from sensitive data while ensuring robust privacy protections, often using techniques such as Differential Privacy, SMPC, and Synthetic Data Generation.

EPPCE (Enhanced Privacy-Preserving Computation Engine or Privacy Engine) 400: A component of the present disclosure that facilitates secure computations on encrypted or sensitive data without exposing raw data, using technologies such as Homomorphic Encryption, Secure Multi-Party Computation, and Trusted Execution Environments.

Federated Learning (FL): A machine learning technique that trains an algorithm across multiple decentralized edge devices or servers holding local data samples, without exchanging their data samples.

Game-Theoretic Incentive Mechanisms: Strategies used within the PREM 500 that leverage game theory principles (rewards, penalties, reputation) to encourage honest and reliable participation by ensemble members.

Homomorphic Encryption (HE): A form of encryption that allows computations to be performed on ciphertext, thus generating an encrypted result that, once decrypted, corresponds to the result of operations performed on the plaintext.

Multi-Modal Biometric Wallet (Wallet) 200 series: A user-controlled software component for securely storing, managing, and using multiple types of Biometric Data for authentication, equipped with adaptive authentication capabilities.

PII (Personally Identifiable Information): Any data that could potentially identify a specific individual.

PII Removal Engine 300 series: An AI-based component of the present disclosure configured to automatically detect and anonymize or pseudonymize PII from various data sources (text, images, etc.) to protect privacy.

POSITA (Person Ordinarily Skilled In The Art): A hypothetical person who is presumed to have ordinary competence in the technical field pertinent to the present disclosure.

PREM (Provably Robust Ensemble Management) 500: A component of the present disclosure configured to ensure the integrity, reliability, and trustworthiness of distributed identity data ensembles, often using game theory-based incentives and verifiable contributions.

Privacy-Enhancing Technologies (PETs): A generic term for technologies that protect personal privacy by minimizing or eliminating the collection of identifiable data, or preventing its unauthorized use.

Secure Enclaves (also Trusted Execution Environments or TEEs): Secure areas within a main processor that ensure that the code and data loaded within them are protected with respect to confidentiality and integrity.

SMPC (Secure Multi-Party Computation): A subfield of cryptography that allows multiple parties to jointly compute a function over their inputs while keeping those inputs private.

Smart Contracts: Self-executing contracts with the terms of the agreement written directly in code. They operate on a blockchain, making them immutable and transparent.

Synthetic Data Generation: The process of creating artificial data that mimics the statistical properties of real-world data without containing any actual individual record, used for testing, training, or analysis while preserving privacy.

TPI (Trustless Positive Identification) System: The present disclosure described herein, a comprehensive system for secure, private, and user-controlled digital identification.

ZKP (Zero-Knowledge Proof): A cryptographic method by which one party (the prover) can demonstrate to another party (the verifier) that it knows a value x, without transmitting any information other than the fact that it knows the value x.

### Multi-Modal Biometric Wallet

According to an embodiment of the present disclosure, an element of the TPI (Trustless Positive Identification) system is the Multi-Modal Biometric Wallet 200, hereinafter referred to as the Wallet. The Wallet 200 differs from prior art biometric authentication systems, introducing an adaptive multimodal approach coupled with robust privacy-preserving functionalities, directly addressing the limitations of static, single-modality, or less privacy-focused solutions. Unlike conventional wallets that may offer limited biometric options or less risk assessment, the Wallet 200 of the present disclosure offers the utility of greater security, user convenience, and greater resilience to spoofing attacks through its dynamic modality selection, intrinsic liveness detection capabilities integral to its adaptive authentication, and context-aware authentication. This integration of adaptive multimodal biometrics with user-centric privacy controls within a comprehensive identity framework constitutes an improvement, offering a more reliable and versatile user authentication experience. As generally illustrated in the overall system architecture of FIG. 1, the Wallet 200 serves as a secure, user-controlled repository for an individual's biometric data and acts as the primary interface for initiating identity verification processes. Preferably embodied as a software application on a user's personal device, the Wallet 200 is designed to provide a robust and flexible means of authentication.

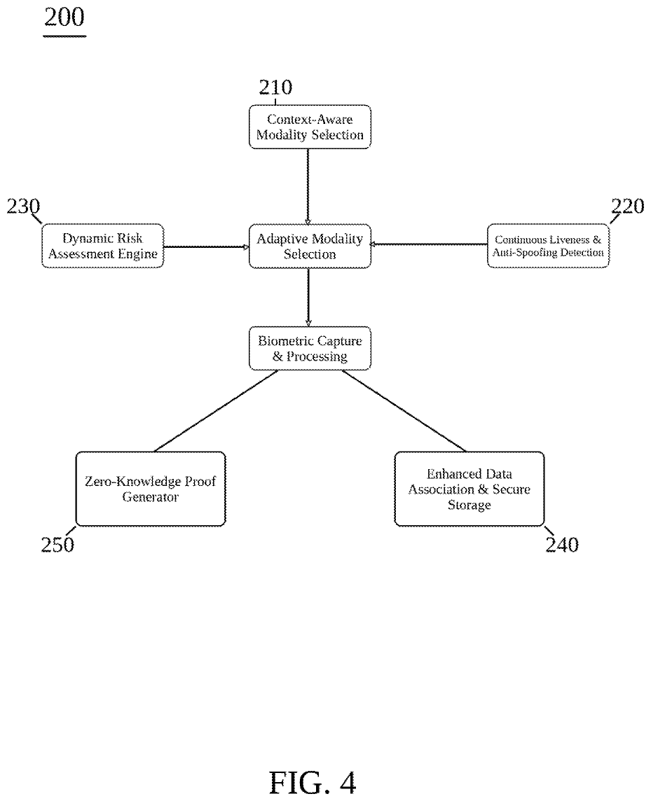

A feature of the Wallet 200 is its advanced adaptive authentication capability. It supports and intelligently manages multiple biometric modalities, such as fingerprint, facial recognition, iris scanning, voiceprint, and behavioral patterns. The Wallet 200 dynamically selects, combines, and weights these modalities, adjusting security rigor based on the risk level of the specific transaction, current environmental conditions, and user preferences. This adaptive process, which may involve considering sensor inputs to understand the operational context and optimize biometric choices accordingly, ensures both security and usability. An exemplary flow diagram of this AI-driven adaptive authentication process is illustrated in FIG. 4. This process includes managing various biometric inputs, applying intelligent weighting, adapting security levels based on risk assessments integral to the system (as shown in FIG. 1), and providing mechanisms for modality switching or user guidance should initial attempts be suboptimal. The ability of the Wallet to fuse biometric information and react to context ensures a high degree of reliability and user convenience. The multimodal biometric authentication system includes a dynamic risk assessment engine 230 that adjusts the authentication requirements based on contextual and behavioral factors.

As illustrated in the adaptive authentication flow of FIG. 4, the dynamic risk assessment engine 230, together with a context-aware modality selection module 210 and a continuous liveness and anti-spoofing detection module 220, provides inputs to an adaptive modality selection that selects and weights the biometric modalities for a subsequent biometric capture and processing operation of the Wallet 200.

As a worked example of the dynamic risk assessment engine 230, the engine 230 receives one or more risk inputs that may include a transaction risk level or transaction value, one or more environmental conditions of a current biometric capture, such as ambient lighting, acoustic noise, or network conditions, one or more behavioral factors associated with the user, and a per-modality quality or confidence measure reported by the one or more biometric sensors. The engine 230 combines the risk inputs into a risk score and compares the risk score against one or more thresholds that define successively higher assurance levels. Based on the assurance level so determined, the engine 230 provides the risk score, or one or more risk inputs derived therefrom, to the context-aware modality selection module 210, which selects and weights the plurality of biometric modalities for a subsequent biometric capture, for example by requiring an additional biometric modality, increasing the weight accorded to a higher-assurance modality, or raising a match threshold for the subsequent biometric capture. In this way, the outcome of the risk assessment for one biometric capture adapts the modality selection and weighting applied to a subsequent biometric capture.

As a worked example of modality weighting and fusion, the context-aware modality selection module 210 assigns to each of the plurality of biometric modalities a weight that depends on at least one of the risk score, a suitability of the modality for the current environmental condition, and the quality or confidence measure reported by the corresponding biometric sensor, and combines per-modality match results into a fused authentication result in accordance with the assigned weights. A modality whose sensor reports low quality under the current environmental condition, such as facial recognition under poor illumination, may be accorded a reduced weight or omitted in favor of another modality, while the fused authentication result is compared against a decision threshold that is set in accordance with the assurance level determined by the dynamic risk assessment engine 230.

Further complementing its authentication capabilities, the Wallet 200 incorporates Enhanced Data Association and Secure Storage 240. This ensures that all Biometric Data is stored with robust security measures. Users benefit from granular control, allowing them to associate different biometric templates or authentication policies with various data access levels or transaction types, such as requiring more stringent verifications for sensitive actions. The system securely links multiple distinct biometric templates to a single user identity, facilitating flexible multi-factor authentication, all while providing users with detailed control over the use of their data in line with the principles of consent and data minimization. The Enhanced Data Association and Secure Storage 240 is also referred to herein as a data association module.

The preservation of user privacy is a design consideration for the Wallet 200. This is achieved through several integral features. Biometric templates stored within its secure storage 240 are preferably encrypted using distinct and robust encryption keys, in turn protected through mechanisms such as hardware-supported Secure Enclaves. For verification processes, the Wallet 200 is designed to use ZKP (Zero-Knowledge Proof) protocols where possible, enabling proof of credential validity without exposing raw Biometric Data. Furthermore, users have the power of selective disclosure, controlling which identity attributes are shared, adhering to data minimization. The Wallet 200 also ensures that raw Biometric Data captured from sensors is processed into templates within a secure on-device environment, with raw data typically not stored long-term or transmitted externally, and templates always protected by strong encryption. For this purpose, the Wallet 200 includes a zero-knowledge proof generator 250 that creates a cryptographic proof of identity without exposing raw biometric data.

This detailed description of the Multi-Modal Biometric Wallet component illustrates its structure, its operation, and how it addresses the need for secure, adaptive, and privacy-preserving biometric authentication within the broader TPI (Trustless Positive Identification) system.

### AI-Powered PII Removal Component

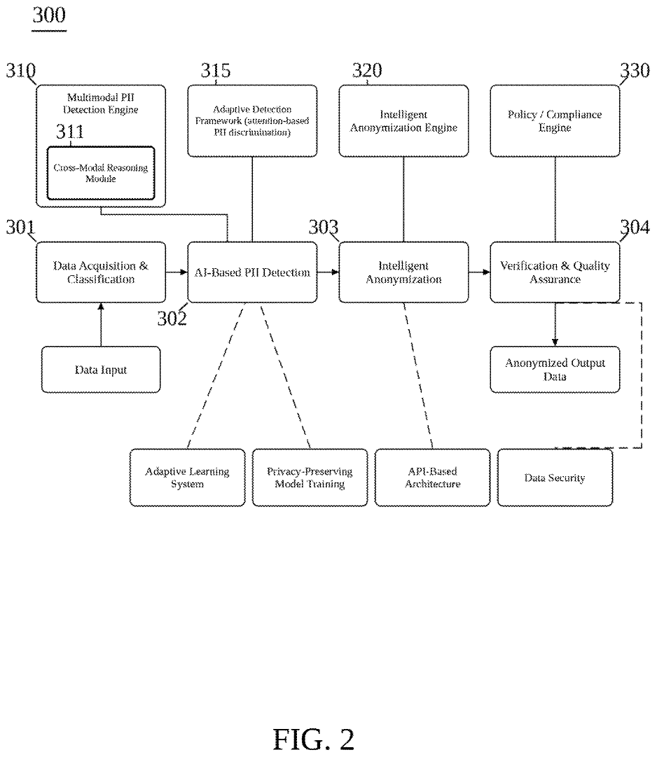

An innovation within the Trustless Positive Identification system is the AI-Powered Personally Identifiable Information (PII) Removal Component 300, hereinafter referred to as the PII Remover. This component 300 differs from prior art PII removal systems, such as those focused on specific domains like medical data for secondary use. The PII Remover 300 distinguishes itself by being a central and integrated part of a comprehensive digital identity framework, designed to proactively protect PII across different data types (text, images, structured data) and interaction contexts. Its utility lies in providing robust automated PII neutralization before data reaches sensitive processing or storage stages, thereby minimizing exposure risks, supporting data minimization principles, and facilitating regulatory compliance. The innovation of employing advanced multimodal AI models for superior contextual understanding and PII detection, together with intelligent anonymization techniques that preserve utility, offers a more holistic solution compared to specialized or less integrated de-identification tools. As illustrated in the detailed architecture of FIG. 2, the PII Remover 300 is designed to automatically detect and neutralize PII across a broad spectrum of data sources, ranging from unstructured text and images to scanned documents and structured databases. Its primary function is to significantly enhance data privacy by ensuring that sensitive personal details are not unnecessarily exposed or retained, thereby robustly supporting data minimization principles and facilitating compliance with stringent regulatory standards. This component 300 is preferably implemented as a data processing service or module, integrable with other system components or existing data management workflows. The PII removal system further includes a policy engine for regulatory compliance 330 that applies configurable privacy policies to the detection and anonymization operations, an adaptive learning system that improves PII detection over time, and a privacy-preserving model training capability that updates the detection models without exposing training data.

As shown in FIG. 2, the artificial-intelligence-based PII removal system 300 is arranged as a processing pipeline through which data passes sequentially via a data acquisition and classification stage 301, an AI-based PII detection stage 302, an intelligent anonymization stage 303, and a verification and quality assurance stage 304, wherein a multimodal PII detection engine 310 and an adaptive detection framework 315 perform the AI-based PII detection, an intelligent anonymization engine 320 performs the intelligent anonymization, and a policy and compliance engine 330 applies configurable privacy policies across the pipeline.

The optimal implementation of the PII Remover 300 depends on the strategic application of artificial intelligence, particularly through the use of advanced multimodal transformer-based architectures and vision-language models. Such models, similar to architectures like GPT-4V, LLaVA, or Claude-3 Vision, are distinguished by their deep ability to simultaneously understand and process information from both textual and visual modalities. This synergistic processing leads to improved contextual understanding and, consequently, accuracy in PII detection.

At the core of this PII Remover 300 lies the Multimodal PII Detection Engine 310. The foundation of this engine 310 is built on large-scale pre-trained transformer models, which are then fine-tuned on extensive and diverse datasets. These datasets are specifically curated to encompass a comprehensive range of PII types across various contexts (such as financial, medical, and general correspondence) and formats (including emails, forms, identification documents, and photographs), ensuring performance. A significant advantage of this architecture is its cross-modal reasoning capability. For example, the engine 310 can intelligently correlate textual mentions of an individual within a document with their image appearing elsewhere in the same document or in a related dataset. This holistic understanding enables more comprehensive and reliable PII linking and subsequent removal.

The cross-modal reasoning capability of the Multimodal PII Detection Engine 310 may be embodied as a cross-modal reasoning module 311 of the engine 310. The cross-modal reasoning module 311 is configured to correlate textual mentions of an individual with visual appearances of the individual across one or more documents, thereby supporting comprehensive PII linking and removal. The engine 310 may include a vision-language model pre-trained on textual and visual data and configured to generate one or more contextual attention maps, derived from attention weights of the transformer layers, that identify regions of text or image content corresponding to sensitive entities in the data associated with the user.

### Core Operational Engines and Their Advanced Capabilities

Complementing the Multimodal PII Detection Engine 310, the PII Remover 300 integrates two other operational engines: the Adaptive Detection Framework 315 and the Intelligent Anonymization Engine 320.

The Adaptive Detection Framework 315 elevates PII detection well beyond rudimentary keyword searching or pattern matching, instilling a deep, context-aware understanding. By leveraging the intrinsic strengths of transformer models, particularly their attention mechanisms, this framework 315 excels at discerning the true meaning of terms within their specific context. This is relevant for accurately distinguishing between innocuous common nouns and true PII instances, for example, differentiating “Brown” as a color from “Mr. Brown” as a personal name. Its advanced Named Entity Recognition (NER) capabilities are significantly enhanced beyond standard categories, enabling the system to identify an exhaustive list of PII. This includes not only common identifiers such as names, aliases, physical and email addresses, phone numbers, and government-issued IDs (such as social security or passport numbers), but also medical record identifiers, financial account details (such as credit card and bank account numbers), and even nuanced textual descriptions that could indirectly lead to biometric identification if not handled. Furthermore, for image and document processing, the framework 315's visual PII detection capabilities are relevant. It implements robust algorithms for face detection, paired with redaction techniques such as strong blurring, pixelation, or even synthetic face replacement where context preservation is relevant and synthetic replacement is unlinkable, preferable alternatives to simple black-box redaction. Advanced Optical Character Recognition (OCR) extracts text from images, which is then intelligently redirected to the language understanding modules to identify PII within its visual context. The framework 315 also employs specialized models or fine-tuning for the challenging tasks of handwritten PII and signature detection, and can be trained to recognize common identity document layouts (e.g., licenses of the driver, passports) to precisely target PII fields typical of such formats. The Adaptive Detection Framework 315 is also referred to herein as a context-aware detection module.

Once PII is accurately identified, the Intelligent Anonymization Engine 320 handles its transformation or removal, with particular attention to preserving data utility to the greatest extent possible. This engine 320 favors context-preserving transformation over mere deletion, which can often destroy the structural integrity or semantic meaning of data. It employs a versatile toolkit of anonymization techniques, including replacing detected PII (such as names and addresses) with realistic yet fictitious synthetic data that maintains the type and format of the original data, for example, replacing a real name with a synthetically generated one appropriate for the demographic context, if known. Another technique is generalization, where specific values are replaced with broader categories, such as an exact date of birth converted to an age range. For identifiers, format-preserving masking is often preferred, such as replacing most digits of a credit card number with ‘X’ while retaining the last four for reference. The engine 320 also demonstrates structured data handling, understanding schema relationships in databases or structured files to ensure, for example, that anonymizing a primary key triggers consistent anonymization of corresponding foreign keys, thereby maintaining referential integrity. Finally, its format-aware processing capabilities ensure that for documents such as PDFs or Word files, anonymization is performed in a way that minimally alters the original layout and formatting, preserving document usability.

### Multi-Stage Processing Pipeline for Optimal PII Removal

To ensure that the PII Remover 300 operates with the utmost effectiveness and precision, its architecture incorporates a multi-stage processing pipeline. This pipeline orchestrates the flow of data through distinct stages, each optimized for a specific aspect of PII removal.

The process begins with Stage 1:

Data Acquisition and Classification 301. Upon receipt of input data, the system intelligently performs automatic data format detection, recognizing common types such as text, PDF, JPEG, or CSV. This is often followed by content type classification, for example, identifying a document as a medical report, a financial statement, or a generic image, which enables subsequent customization of PII detection strategies based on the specific nature of the data. Comprehensive pre-processing steps are then undertaken, including data cleaning, normalization (such as standardizing date formats), and preparing data for optimal consumption by AI models. For image-based data, this stage may also involve image enhancement techniques such as resolution improvement or noise reduction.

After initial acquisition and preparation, data progresses to Stage 2: AI-Based PII Detection 302

Here, pre-processed data is channeled into the Multimodal PII Detection Engine 310 and the Adaptive Detection Framework 315. These advanced AI systems work in concert to identify potential PII instances. An aspect of this stage is the assignment of confidence scores to each detected PII instance. This nuanced scoring allows for flexible management, such as applying anonymization only to PII detected above a certain confidence threshold, or flagging low-confidence detections for human review, thereby balancing automation with precision. Furthermore, contextual validation mechanisms are employed, such as cross-referencing PII found in textual content with elements present in visual data, to significantly improve detection accuracy and minimize false positives.

Once PII has been identified, the process advances to Stage 3: Intelligent Anonymization 303

In this stage, the Intelligent Anonymization Engine 320, also referred to as an intelligent anonymization module, applies the most appropriate anonymization techniques for each detected PII instance, based on the PII type, the context in which it appears, and the confidence level of the detection. Anonymization decisions are guided by a set of configurable rules and privacy policies that can be customized according to the specific requirements of the organization or use case. These rules may specify, for example, that social security numbers must always be fully masked, while names may be replaced with synthetically generated pseudonyms. A particular aspect of this stage is its ability to maintain transformation consistency across an entire corpus of documents or datasets, ensuring that the same real-world entity receives the same anonymization treatment wherever it appears, thereby preserving semantic relationships in the data while removing PII.

Finally, the process concludes with Stage 4: Verification and Quality Assurance 304

This final stage is designed to ensure that the PII removal process has achieved its objectives without unduly compromising data utility. It includes automated checks to confirm that all high-confidence PII instances have been adequately treated, and may optionally include a human review step for ambiguous or high-risk cases. Furthermore, this stage may perform data utility tests to verify that the anonymized data still maintains the statistical properties or characteristics necessary for its intended use. For the most sensitive use cases, formal re-identification risk assessments may also be implemented, using techniques such as k-anonymity analysis or applying simulated re-identification attacks to evaluate the robustness of anonymization. The results of these checks and assessments are documented in detailed reports that provide transparency on the PII removal process and can serve as evidence of compliance with privacy regulations.

This detailed description of the AI-Powered PII Removal component illustrates its structure, its operation, and how it addresses the need for accurate, and utility-preserving PII removal within the broader Trustless Positive Identification system.

An aspect of its design is an API-based architecture. The PII Remover 300 is architected to expose its full capabilities through secure Application Programming Interfaces (APIs), such as RESTful services. This approach facilitates simple and flexible integration into other components of the Trustless Positive Identification system or enables easy incorporation into existing enterprise workflows and third-party applications, thereby maximizing its utility and reach.

Complementing its flexible integration is an commitment to data security. The system enforces rigorous security protocols, including mandatory end-to-end encryption for all data, both when in transit across networks and when at rest in storage. In scenarios where processing tasks are performed in cloud environments, the PII Remover 300 promotes the use of confidential computing environments, such as Secure Enclaves. These specialized environments provide an additional layer of protection during AI model inference, safeguarding both the sensitive data being processed and the proprietary AI models themselves from unauthorized access or exposure.

By implementing the AI-Powered PII Removal component 300 in this manner, the Trustless Positive Identification system can effectively reduce the privacy risks associated with PII, thereby fostering user trust and ensuring compliance with data protection regulations.

### Advanced Privacy-Preserving Computation Engine

According to an embodiment of the present disclosure, the Trustless Positive Identification system incorporates an Enhanced Privacy-Preserving Computation Engine 400 (hereinafter “Privacy Engine”). This Privacy Engine 400 differs from conventional data processing systems by providing a comprehensive framework for performing complex calculations and even AI model training directly on encrypted or otherwise protected data. Unlike prior art systems that might offer isolated Privacy-Enhancing Technologies (PETs) or focus on specific types of computation, the EPPCE 400 offers the utility of a versatile and integrated engine. It combines multiple advanced PETs (e.g., HE, ZKPs, SMPC, FL) with an AI-driven adaptive privacy controller and a cognitive proof system, enabling a broader range of secure operations while providing verifiable integrity and explainable privacy. This fusion addresses the need for robust data protection during computation in a digital identity context, an advancement that improves user trust and facilitates complex data interactions without compromising confidentiality. This capability is relevant for operations such as privacy-preserving biometric matching, secure data analysis, and other computations where data confidentiality is paramount. The Privacy Engine 400 aims to provide solid mathematical privacy guarantees while ensuring the verifiability and integrity of computational results.

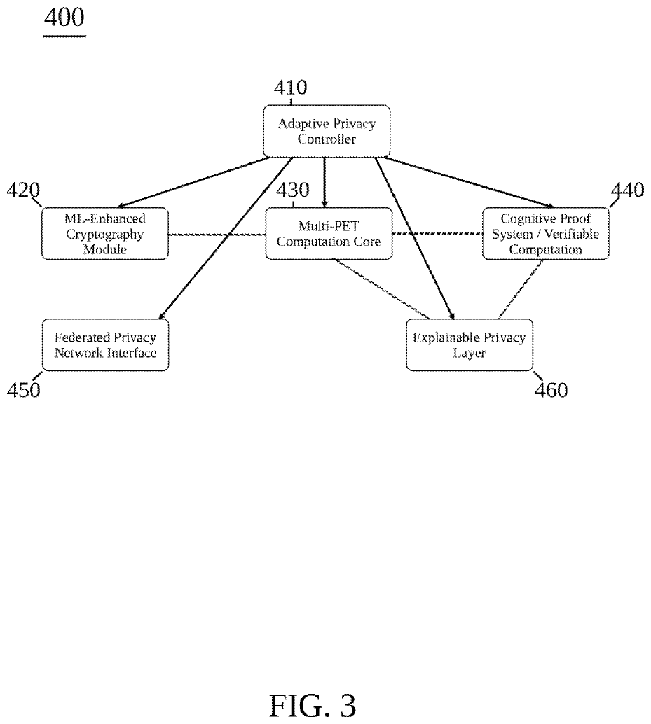

Referring to FIG. 3, a detailed architecture of an exemplary Enhanced Privacy-Preserving Computation Engine 400 is illustrated. The Privacy Engine 400 is designed as a computational framework that integrates various cryptographic techniques and distributed computation paradigms.

As shown in FIG. 3, the privacy-preserving computation engine 400 comprises an adaptive privacy controller 410 coupled to an ML-enhanced cryptography module 420, a multi-PET computation core 430, and a cognitive proof system 440, the adaptive privacy controller 410 being further coupled to a federated privacy network interface 450 and an explainable privacy layer 460, and the multi-PET computation core 430 and the cognitive proof system 440 being coupled to the explainable privacy layer 460.

### AI-Driven Adaptive Privacy Engine/Decentralized Verifiable Computation Network

This component emphasizes the distribution of privacy-sensitive computations across multiple independent nodes, ensuring that no single party has access to all data and enabling cryptographic verification of results. Furthermore, the incorporation of AI to dynamically adapt privacy levels (an AI-Driven Adaptive Privacy Engine) represents an enhancement.

The concept of this preferred embodiment is to establish a system in which data owners can confidently submit their encrypted or otherwise transformed data for computation. These computations are then performed by a distributed network of nodes, designed to operate in a manner that protects the confidentiality of input data. An aspect of this system is its verifiability; the correctness of any computation can be independently confirmed by the data owner or other authorized parties without requiring re-execution of the entire computation or access to the sensitive raw data. Furthermore, the system embodies intelligent adaptability, allowing dynamic adjustment of privacy levels. This adjustment is responsive to the specific sensitivity of the data involved, the intrinsic nature of the computation being performed, and the prevailing risk context, with such dynamic control potentially guided by AI-driven controllers to ensure an optimal balance between privacy and utility.

### Main Architectural Components and Operational Principles

The Privacy Engine 400 is best implemented through a synergistic combination of several advanced technologies and components:

### Adaptive Privacy Controller

The adaptive privacy controller 410 serves as an intelligent component within the Privacy Engine 400, specifically tasked with the dynamic management and optimization of the delicate balance between privacy preservation and computational utility. Its primary function involves a thorough assessment of the context surrounding each computational request. This assessment comprises a detailed analysis of data sensitivity, often derived from associated metadata or predefined user policies, the specific type of computation being performed, and the desired level of accuracy or utility for the output. According to an exemplary incarnation, the controller 410 leverages advanced AI-driven decision-making processes. It uses machine learning models to proactively predict potential privacy risks and to intelligently select the most appropriate and effective cryptographic techniques, such as choosing a specific type of Homomorphic Encryption, determining the optimal Secure Multi-Party Computation protocol, or setting precise Differential Privacy parameters, for any given task. This AI-powered controller 410 is designed to learn from past interactions and overall system performance, continuously refining its strategies to improve both privacy protection and operational efficiency. Furthermore, a responsibility of the Adaptive Privacy Controller 410 is rigorous policy enforcement. It ensures that all computations strictly adhere to privacy policies defined by users or the system administrator, including compliance with predefined privacy budgets or other operational constraints, thereby maintaining the integrity and reliability of privacy-preserving computations. For example, the adaptive privacy controller 410 may use reinforcement learning to optimize one or more privacy parameters based on system feedback and one or more user requirements, in which a state characterizes a context of a computational request, including data sensitivity and a desired utility, an action selects a privacy-enhancing technique or a parameter thereof, and a reward reflects an achieved privacy-utility balance and compliance with one or more privacy policies or privacy budgets, such that the controller 410 refines its selection strategy over successive requests.

### ML-Enhanced Cryptography Module

The ML-Enhanced Cryptography Module 420 represents a significant innovation within the Privacy Engine 400, integrating machine learning techniques with robust cryptographic methods to strengthen both security and operational efficiency. A primary function of this module 420 is capable technique selection; acting under the direction of the Adaptive Privacy Controller 410, it intelligently selects and configures the most suitable cryptographic primitives for the task at hand. This dynamic selection process might involve choosing optimal parameters for various Homomorphic Encryption schemes, selecting the most appropriate secret sharing schemes for Secure Multi-Party Computation (SMPC) protocols, or determining the precise noise levels necessary to effectively implement Differential Privacy. Beyond selection, machine learning is also skillfully employed for optimized cryptographic operations. For example, ML models can predict the most efficient way to structure a complex homomorphic computation or optimize intricate communication patterns within SMPC protocols, thereby improving overall performance.

A compelling application example of this module capabilities of the 420 is in private biometric matching. In such a scenario, the Privacy Engine 400, through this module, enables two parties, such as the user's Multi-Modal Biometric Wallet 200 and an external verifier, to securely compare a newly acquired biometric template with a previously registered one. Notably, this comparison is performed without either party having to reveal their sensitive biometric template to the other, thereby preserving privacy. Such private matching can be achieved using advanced cryptographic techniques such as Homomorphic Encryption, which allows computations directly on encrypted templates, or through two-party secure computation protocols specifically designed to compute distance metrics (e.g., Hamming distance for iris codes or Euclidean distance for facial embeddings).

### Multi-PET Computation Core

The Multi-PET Computation Core 430 component is dedicated to the challenge of maximizing the utility derived from computations while adhering to predefined and stringent privacy constraints. An aspect of its functionality involves the expert application of Differential Privacy mechanisms. Particularly for computations involving statistical queries or analytical operations on datasets comprising information from multiple individuals, Differential Privacy emerges as a technique. This component 430 is designed to determine the optimal methodology for injecting precisely calibrated noise into data or query results. This noise injection is carefully managed to satisfy formal Differential Privacy guarantees, thereby protecting individual data, while simultaneously minimizing any negative impact on the accuracy and reliability of computational results. An element of this process is the management of a “privacy budget,” which quantifies and limits the total amount of information that can be permissibly disclosed about any single individual across a series or sequence of queries. Furthermore, the Multi-PET Computation Core 430 component employs utility-preserving transformations. Before the commencement of any computation, data may undergo various transformations, such as generalization to broader categories, suppression of specific sensitive details, or other advanced anonymization techniques. These transformations are intelligently designed to preserve data utility for the specific intended computation while simultaneously enhancing the overall level of privacy protection afforded to the underlying information.

Cognitive Proof System/Verifiable Computation 440 A component of the Enhanced Privacy-Preserving Computation Engine 400, herein referred to as Privacy Engine, is the cognitive proof system/verifiable computation module 440. This system addresses the aspect of ensuring and demonstrating that computations have been performed correctly and honestly, a capability particularly vital when computations are outsourced to potentially untrusted third-party nodes or when operations are performed on encrypted data where direct inspection is impossible. A primary mechanism employed by this module 440 is the generation and verification of Zero-Knowledge Proofs (ZKPs) for computations. This advanced cryptographic technique involves the creation of compact proofs (such as, but not limited to, zk-SNARKs or zk-STARKs) that attest to the correctness of a specific computation without requiring the revelation of the underlying input data. For example, a computational node performing a homomorphic computation on encrypted data could generate an associated ZKP. This proof would incontrovertibly demonstrate that the resulting ciphertext accurately corresponds to the specified mathematical function correctly applied to the input ciphertexts, all while maintaining the confidentiality of the data itself. To further enhance trust and transparency, especially within decentralized network environments, the system 440 can leverage blockchain-based verification. In such implementations, cryptographic proofs of computation are recorded on a distributed ledger or blockchain, thereby establishing an immutable, transparent, and easily verifiable record of all verified computations. Smart Contracts can then be deployed to automate the verification process of these proofs and to subsequently trigger predefined actions, such as the release of payments for computational services rendered or the secure dissemination of verified results. Recognizing that ZKP generation can be computationally intensive for complex operations, the module 440 also supports distributed proof generation. This approach allows the task of creating a single comprehensive proof to be efficiently partitioned and distributed among multiple participating nodes, significantly improving the speed and scalability of the proof generation process.

### Federated Privacy Network Interface

The federated privacy network interface 450 equips the Privacy Engine 400 with the essential capabilities to interact securely and effectively with external systems and to participate in collaborative, distributed computations, such as federated learning, while maintaining rigorous privacy standards. An aspect of this interface 450 is its implementation of secure data exchange protocols. These protocols are designed to ensure that any data exchanged with other entities or participating nodes is fully protected through the mandatory use of secure communication channels and robust encryption mechanisms, thereby safeguarding data integrity and confidentiality during transit and processing. Furthermore, the interface 450 facilitates policy negotiation, a function that enables the Privacy Engine 400 to proactively engage with other participating systems to establish and agree upon mutual privacy terms, data handling protocols, and security measures before undertaking any collaborative computational activity. This negotiation ensures that all parties operate with a common and explicit understanding of privacy expectations and obligations, fostering an environment of trust for federated operations.

### Explainable Privacy Layer

To cultivate user trust and simplify audit processes, the Enhanced Privacy-Preserving Computation Engine 400 incorporates an explainable privacy layer 460. This layer is dedicated to providing clear and comprehensible insights into the mechanisms and extent of privacy protection offered by the system. A function of this layer 460 is the generation of transparency reports. These reports, which may also take the form of intuitive visualizations, are designed to explain, in an accessible and understandable manner, the specific privacy-enhancing techniques applied in any computation. They also articulate the level of privacy protection achieved, for example, indicating the epsilon value in Differential Privacy implementations, and offer clarity on how privacy budgets are allocated and managed during various operations. Complementing its reporting capabilities, the Explainable Privacy Layer 460 ensures auditability. It provides mechanisms and robust interfaces that enable authorized auditors to effectively verify the compliance of the system with established privacy policies, data protection regulations, and user-defined consent parameters, thereby reinforcing the accountability and overall integrity of the privacy-preservation framework.

### Operational Flow Example

To illustrate the practical application of the Enhanced Privacy-Preserving Computation Engine 400, consider a scenario in which a user wishes to verify their identity with a service provider using their unique biometric data, with the stipulation that their raw biometric template must not be revealed to the service. The process unfolds as follows: Initially, both the user's Multi-Modal Biometric Wallet (indicated generally in FIG. 1, with specific wallet functionalities detailed in relation to FIG. 4) and the service's designated verifier component invoke the capabilities of the Privacy Engine 400. Upon receiving the request, the Adaptive Privacy Controller 410 evaluates the context and requirements, subsequently determining the most appropriate privacy-preserving biometric matching protocol, such as a comparison based on homomorphic encryption. Following this determination, the ML-Enhanced Cryptography Module 420 configures the selected protocol; the Wallet of the user then encrypts the newly acquired biometric template, while the verifier uses its corresponding securely stored encrypted registered template. The main computation, for example, the calculation of a distance metric between these two encrypted templates, is then performed by one or more trusted nodes operating within the Privacy Engine 400's secure network. Simultaneously, the cognitive proof system 440 generates a cryptographic proof, attesting that the computation was performed accurately and according to the established protocol, without any deviation. The result of this computation (e.g., a boolean match/non-match decision, or an encrypted similarity score) together with the generated proof, is then securely returned. The verifier can independently check the validity of the proof to obtain assurance of the integrity of the result. Finally, to reinforce user trust, the Explainable Privacy Layer 460 can provide a clear attestation to the user, confirming that their sensitive biometric data remained confidential and protected throughout the entire verification process.

By implementing the Enhanced Privacy-Preserving Computation Engine 400 with these principles and components, the Trustless Positive Identification system enables the secure and private execution of a wide range of sensitive computations, essential for building a trustworthy digital identity ecosystem.

### Blockchain-Agnostic Infrastructure

According to an embodiment of the present disclosure, an innovation of the Trustless Positive Identification system is its Blockchain-Agnostic Infrastructure 700 (hereinafter “BAI”). The BAI 700 differs from systems that rely on a single, specific blockchain technology. By providing a modular abstraction layer and dynamic ledger selection, it addresses the limitations of vendor lock-in, lack of interoperability, and inability to adapt to the evolving DLT landscape. The utility of the BAI 700 is profound: it offers the TPI system unparalleled flexibility, future-proofing, and the strategic advantage of leveraging the unique strengths (e.g., cost, security, privacy, performance) of different DLTs as best suited to specific transactions or data types. This approach of creating a universal intermediary for interaction with multiple heterogeneous blockchain platforms is a solution that enhances the resilience, adaptability, and long-term sustainability of the system. Its primary purpose is to enable the system to interact with, and store or verify data across, these various platforms

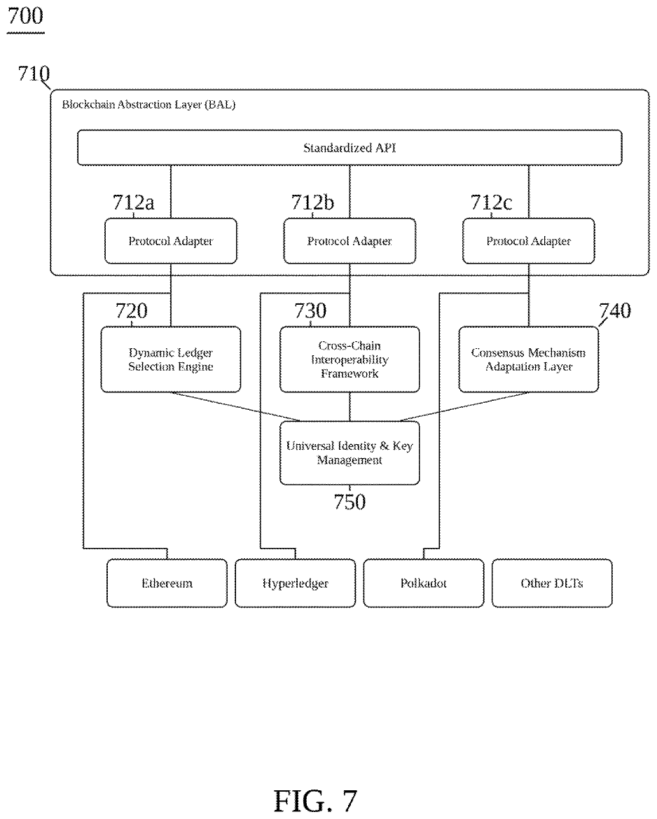

The role and position of the Blockchain-Agnostic Infrastructure 700 within the overall system architecture are generally depicted in FIG. 1, and its detailed architecture is illustrated in FIG. 7. The BAI 700 acts as an intermediary layer that abstracts the complexities of individual blockchain protocols.

As shown in FIG. 7, the blockchain-agnostic infrastructure 700 comprises a blockchain abstraction layer 710 that exposes a standardized API and includes a plurality of protocol adapters 712, a dynamic ledger selection engine 720, a cross-chain interoperability framework 730, a consensus mechanism adaptation layer 740, and a universal identity and key management component 750, the protocol adapters 712 interfacing the blockchain abstraction layer 710 with a plurality of distributed ledger technologies such as Ethereum, Hyperledger, and Polkadot.

### Modular Abstraction Layer with Dynamic Ledger Selection

The preferred embodiment for implementing the Blockchain-Agnostic Infrastructure (BAI) 700 focuses on a modular abstraction layer 710 that operates in conjunction with an intelligent dynamic ledger selection (DLS) mechanism 720. This architectural synergy primarily enables the system to define standardized interfaces for a range of common blockchain operations, such as data anchoring, smart contract interactions, and identity attestation. The BAI 700 can then dynamically choose the most suitable blockchain for a given transaction or data type based on predefined policies, cost, security, privacy characteristics, or performance. The concept driving this embodiment is the strategic decoupling of the Trustless Positive Identification system's core operational logic from the specific and varied implementations of the underlying blockchain technologies, ensuring adaptability and resilience.

### Main Architectural Components and Operational Principles

The BAI 700 is best implemented through the following interconnected components:

### Blockchain Abstraction Layer (BAL)

The Blockchain Abstraction Layer (BAL) 710 serves as the heart of the Blockchain-Agnostic Infrastructure (BAI) 700, notably providing a unified and consistent interface toward a multitude of diverse blockchain networks. A feature of the BAL 710 is its standardized API, which exposes a coherent set of Application Programming Interfaces (APIs) designed to handle operations common blockchain operations with a uniform approach, regardless of the underlying ledger technology. These operations include, for example, an anchorData(data, metadata, policy) function, which enables the immutable registration of a data hash or proof on a ledger; a verifyData(proofIdentifier) function, used to retrieve and verify previously anchored data; a deployContract(contractCode, parameters, policy) function, for deploying smart contracts on a selected blockchain; an invokeContract(contractAddress, functionName, arguments, policy) function, which facilitates interaction with already deployed smart contracts; and a registerIdentityAttestation(attestation, policy) function, designed to register identity-related attestations or declarations in a secure and verifiable manner. This standardized suite of API calls ensures that higher-level application logic can interact with blockchain functionalities consistently, abstracting away the specific complexities of individual blockchain protocols.

Supporting this standardized interface, the BAL 710 incorporates a layer of protocol adapters/connectors 712. These components (generically denoted as 712a, 712b, 712c, and so on, corresponding to specific DLTs) operate beneath the standardized API. Each adapter is designed to translate the BAL's generic API calls into the native protocol messages, transaction formats, and specific interaction patterns required by a particular blockchain network. This includes widely used platforms such as Ethereum, Hyperledger Fabric, or Polkadot, as well as potentially more specialized and privacy-focused chains such as Zcash or Monero (if used for specific anonymous attestations), or any other next-generation DLT. For example, an anchorData call made through the BAL 710 could be translated by an Ethereum-specific adapter (e.g., 712a) into an Ethereum transaction that writes a hash to a designated smart contract. Conversely, a Hyperledger Fabric adapter (e.g., 712b) could translate the same generic anchorData call into the necessary endorsement and commit procedures specific to a private channel within that Fabric network.

A significant advantage of this architecture is its inherent extensibility. The modular design of the BAL 710, particularly its reliance on distinct protocol adapters 712, allows new adapters to be readily developed and integrated (or “plugged in”) as new blockchain technologies emerge, gain prominence, or become relevant to the objectives of the system. This capability ensures that the BAI 700 can adapt to the rapidly evolving DLT landscape without requiring modifications to the core application logic that interfaces with the BAL's standardized API, thereby future-proofing the system.

### Dynamic Ledger Selection (DLS) Engine

The Dynamic Ledger Selection (DLS) Engine 720 provides the BAI 700 with the intelligence necessary to determine and select the most suitable blockchain or distributed ledger technology (DLT) for any given operation or transaction. A primary mechanism through which the DLS Engine 720 achieves this is through policy-based routing. This allows system administrators or, in certain configurations, end users to define and implement policies that govern and guide the ledger selection process. Such policies are configurable and can be based on a wide range of factors. For example, data sensitivity is a consideration, whereby sensitive or confidential data may be preferably routed to permissioned blockchains or those DLTs specifically designed with robust built-in privacy-enhancing features. Another significant factor is transaction cost; for operations characterized by high volume but relatively low individual transaction value, the DLS Engine 720 can be configured to select blockchains known for their lower transaction fees, thereby optimizing operational expenses. Furthermore, performance requirements play a role, with operations requiring high throughput capacity or minimal latency being intelligently directed toward specific high-performance DLTs designed to meet such rigorous demands. Regulatory compliance also heavily influences ledger selection, as certain types of data or operations within specific jurisdictions may be subject to legal or regulatory mandates that stipulate the use of particular approved ledgers. Finally, the level of security required for an operation is relevant; transactions or data anchoring processes requiring the highest level of security and immutability could be routed toward established public blockchains that benefit from significant and widely distributed hash power or other robust consensus mechanisms.

Beyond policy-driven decisions, the DLS Engine 720 can enhance its routing capabilities through real-time metrics analysis. This optional but functionality enables the engine 720 to actively monitor dynamic network conditions in real time across the suite of connected blockchains. Such conditions may include, but are not limited to, current transaction fees, average block confirmation times, and prevailing levels of network congestion. By ingesting and analyzing these live metrics, the DLS Engine 720 can make more informed, adaptive, and contextually relevant routing decisions, potentially overriding or refining policy-based selections when immediate network conditions significantly favor one ledger over another for a specific operation.

Finally, to ensure operational continuity and simplicity for common or non-critical operations, the DLS Engine 720 supports a default ledger configuration. This allows a specific blockchain or DLT to be pre-designated as the default target for any operation where no explicit policy mandates an alternative ledger, or where real-time metrics do not strongly suggest a deviation. This default setting provides a baseline routing path, simplifying system configuration and ensuring that all transactions have a defined destination even in the absence of specific routing intelligence.

### Cross-Chain Communication and Interoperability Framework

To address and enable more complex operational scenarios, particularly those involving the transfer of assets, value, or data attestations across disparate blockchain networks, the Blockchain-Agnostic Infrastructure (BAI) 700 incorporates a cross-chain communication and interoperability framework 730. A capability of this framework 730, particularly pertinent for value or state transfer, is its ability to implement or integrate with established protocols for atomic swaps and/or cross-chain bridges. Atomic swaps facilitate trustless, peer-to-peer exchanges of assets directly between different blockchains without relying on intermediaries. Alternatively, or in conjunction, the framework 730 can utilize various trusted or trustless cross-chain bridge mechanisms, which act as conduits to enable the movement of assets or information from one blockchain ecosystem to another, thereby significantly enhancing the interoperability and reach of the system.

Furthermore, the framework 730 is designed to actively leverage interoperability protocols. This involves the ability to integrate with and utilize emerging industry standards and protocols specifically developed to foster communication and data exchange between heterogeneous ledger environments. Examples of such protocols include, but are not limited to, Polkadot's Cross-Consensus Message Format (XCMP) or Cosmos's Inter-Blockchain Communication (IBC) protocol. By embracing these and similar evolving standards, the BAI 700 ensures it can effectively bridge communication gaps and enable data interactions across a diverse and expanding landscape of blockchain technologies.

A challenge in multi-ledger environments is maintaining data integrity, which the framework 730 addresses through robust data consistency management. In scenarios where data related to a single logical entity, transaction, or state is distributed or replicated across multiple distinct ledgers, this framework 730 must incorporate mechanisms. These mechanisms are responsible for actively managing data consistency, detecting and resolving potential conflicts or discrepancies that may arise due to the asynchronous nature of distributed systems. To achieve this, the framework 730 may employ various strategies, potentially including the use of global distributed consensus protocols to agree on a unified state, or implementing transactional strategies similar to two-phase commit (2PC) that have been specifically adapted for the unique characteristics and constraints of blockchain-based environments, thereby ensuring a consistent and reliable view of data across all involved ledgers.

### Consensus Mechanism Adaptation Layer

Given that different blockchain networks employ a wide range of consensus mechanisms, such as, but not limited to, Proof-of-Work (PoW), Proof-of-Stake (PoS), Proof-of-Authority (PoA), or various Byzantine Fault Tolerant (BFT) variants, the Blockchain-Agnostic Infrastructure (BAI) 700 incorporates a consensus mechanism adaptation layer 740. The primary function of this layer 740 is to ensure that the BAI 700 can accurately interpret and appropriately act upon the distinct finality characteristics and security guarantees offered by each connected ledger. To achieve this, the layer 740 may include finality gadgets or equivalent logic. For example, when interacting with chains that exhibit probabilistic finality, as typical of PoW-based blockchains, this layer 740 is equipped to implement specific logic, such as waiting for a predetermined and sufficient number of block confirmations to elapse before considering a transaction as effectively final and irreversible. This adaptive approach to finality ensures that the BAI 700 operates with a consistent understanding of transaction settlement across heterogeneous DLTs.

Complementing its finality management, the consensus mechanism adaptation layer 740 also performs consensus monitoring. This involves the active observation and tracking of the consensus-reaching processes of the underlying connected blockchains. By monitoring these processes, the layer 740 helps ensure the ongoing integrity and reliability of the data being recorded on or relied upon from these ledgers, providing an additional level of assurance regarding the validity of blockchain states and transactions.

### Universal Identity and Key Management

While the user's Multi-Modal Biometric Wallet 200, with its overall role depicted in FIG. 1 and detailed aspects in FIG. 2, is primarily responsible for managing the end user's primary cryptographic keys, the Blockchain-Agnostic Infrastructure (BAI) 700, as part of the overall system in FIG. 1, often requires its own mechanisms for managing system-level keys or identities. These are necessary for the BAI 700 to autonomously interact with various connected blockchains, performing actions on behalf of the overall system or its constituent services. To address this, the BAI 700 includes a universal identity and key management component 750. A function of this component 750 is to provide abstracted key management. This involves offering a secure, robust, and abstracted methodology for managing the diverse cryptographic keys essential for authorizing and signing transactions across the spectrum of supported blockchain networks. To ensure high levels of security, this abstracted key management may involve deep integration with specialized hardware, such as Hardware Security Modules (HSMs), or leveraging dedicated secure key management services designed to protect sensitive key material from unauthorized access and misuse.

Beyond key management, the universal identity and key management component 750 also facilitates identity correlation. This becomes particularly important when the overall Trustless Positive Identification system, or an entity operating within it, must be consistently represented across multiple distinct blockchain networks. In such cases, this component 750 provides the tools and logic necessary to manage and correlate these distributed identities. A preferred approach for achieving this involves the use of Decentralized Identifiers (DIDs). DIDs offer a globally unique, verifiable, and blockchain-agnostic way to identify entities, and can be designed to resolve to different blockchain-specific addresses or accounts as needed. By leveraging DIDs or similar mechanisms, the component 750 ensures that a single logical identity can be consistently maintained and recognized across the diverse landscape of interconnected DLTs, simplifying cross-chain interactions and identity assertions.

### Operational Example: Anchoring an Attestation

To illustrate the practical operation of the Blockchain-Agnostic Infrastructure (BAI) 700, consider an example scenario involving the anchoring of a privacy-preserving attestation. The process begins when a system component, such as the Enhanced Ensemble Management system, determines the need to securely anchor an attestation, for example, a cryptographic proof of a verified credential. This initiating component then invokes a function, such as anchorData(attestationProof, metadata, policy), provided by the Blockchain Abstraction Layer (BAL) 710. Along with the attestationProof itself and any relevant metadata, the calling component specifies a policy that might, for example, indicate a preference for a public, high-security blockchain suitable for this type of attestation. The attestation anchored on the distributed ledger is generated based on at least the zero-knowledge proof; for example, the attestation may comprise the zero-knowledge proof itself, or may be generated upon successful verification of the zero-knowledge proof.

Upon receiving this request, the Dynamic Ledger Selection (DLS) Engine 720 evaluates the provided policy in conjunction with current network conditions and other configured parameters, ultimately selecting an appropriate target ledger, for this example, let us assume it selects the Ethereum mainnet. Subsequently, the BAL 710 routes the anchoring request to the specific protocol adapter corresponding to the selected ledger, in this case, the Ethereum adapter (one of the protocol adapters/connectors 712). This adapter then assumes the responsibility of constructing a valid Ethereum transaction tailored to the request, which might involve, for example, invoking a function on a pre-deployed registry smart contract and embedding the attestationProof within the transaction data.

Before the transaction can be submitted, the universal identity and key management component 750 is called upon to provide the necessary cryptographic signature, using a system-managed Ethereum key securely stored and managed by this component 750. Once signed, the transaction is submitted to the Ethereum network. The consensus mechanism adaptation layer 740 then monitors the network for transaction confirmation. After a sufficient number of confirmations have been observed, indicating finality, a transaction receipt or unique identifier for the anchored data is returned to the original calling component, completing the attestation anchoring process.

The Blockchain-Agnostic Infrastructure 700 thus provides the Trustless Positive Identification system with significant operational flexibility, reduces vendor lock-in, and enables it to strategically leverage the evolving landscape of blockchain technologies.

### Advanced Ensemble Management

The Trustless Positive Identification system features an Enhanced Ensemble Management component 800 (hereinafter “EEM”). The EEM 800 operates by establishing a framework for secure and privacy-preserving collaboration among multiple potentially distrustful entities. Unlike simpler federated systems or basic data sharing agreements found in prior art, the EEM 800 provides the utility of a comprehensive orchestration layer. This layer includes a federated orchestrator, a robust privacy architecture leveraging the EPPCE 400, a privacy-preserving consensus engine, an interoperability framework, and trust/reputation management. This combination facilitates complex cross-organizational workflows, such as federated fraud detection or collaborative identity verification, without centralizing sensitive data. This approach is a solution to the challenge of enabling collective intelligence and action while maintaining rigorous privacy and security standards, thereby improving operational efficiency and trust in distributed environments. Its primary purpose is to orchestrate a federated network in which members can contribute data or computational resources to achieve a common identification or verification objective while maintaining control over their own assets.

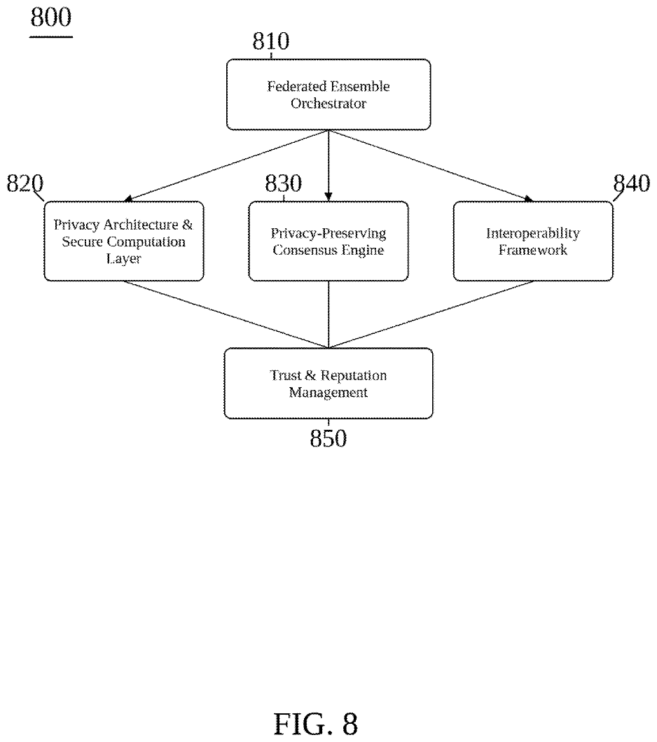

The architecture of the enhanced ensemble management system 800 is illustrated in FIG. 8. Referring to FIG. 8, the enhanced ensemble management system 800 comprises a federated ensemble orchestrator 810, a privacy architecture and secure computation layer 820, a privacy-preserving consensus engine 830, an interoperability framework 840, and a trust and reputation management system 850. The federated ensemble orchestrator 810 is coupled to, and coordinates the operation of, the privacy architecture and secure computation layer 820, the privacy-preserving consensus engine 830, and the interoperability framework 840, each of which is in turn coupled to the trust and reputation management system 850 that monitors the participation and reliability of the members across the ensemble.

The Enhanced Ensemble Management system 800 is architecturally designed to provide the framework and protocols for establishing, managing, and governing these collaborative ensembles.

### Federated Ensemble Orchestration with Privacy-Preserving Consensus

The preferred implementation mode of the EEM 800 focuses on federated ensemble orchestration 810 coupled with a robust privacy-preserving consensus engine 830 and a flexible interoperability framework 840. This synergistic approach facilitates a robust framework capable of supporting several main operational capabilities. First, it enables the formation and decentralized ensemble governance, allowing groups of organizations to self-organize and establish shared rules and operational parameters without depending on a central authority. Second, it ensures the secure execution of distributed workflows, where complex processes involving sensitive data contributions from multiple members can be executed with strong guarantees of data protection and integrity. Third, a capability is the achievement of consensus on the results of these collaborative workflows without requiring the disclosure of raw data by any single member, a function primarily supported by the privacy-preserving consensus engine 830. Finally, the intrinsic design, particularly through the interoperability framework 840, promotes interoperability with the diverse range of systems and data formats that are typically used by different ensemble members, thereby lowering barriers to participation and integration.

The concept is to create a dynamic and secure environment in which organizations can collaborate on identity-related tasks, such as fraud detection, KYC/AML compliance, or attribute verification, leveraging shared insights without directly sharing underlying sensitive datasets.

### Main Architectural Components and Operational Principles

The EEM 800 is preferably implemented through the following interconnected components:

### Federated Ensemble Orchestrator

The federated ensemble orchestrator 810 serves as the central nervous system for the EEM 800, assuming primary responsibility for the complete lifecycle management of collaborative ensembles and the intricate coordination of distributed tasks undertaken by their members. A set of functionalities provided by the Orchestrator 810 concerns ensemble formation and governance. This encompasses a suite of robust tools and protocols designed to facilitate the establishment and ongoing management of these federated groups. Specifically, the Orchestrator 810 enables the clear definition of ensemble membership criteria and provides streamlined mechanisms for the secure onboarding of new members into an ensemble. Furthermore, it plays a role in establishing and enforcing governance rules, operational policies, and data sharing agreements that dictate the terms of collaboration; notably, these agreements and rules can themselves be codified and automatically enforced using smart contracts deployed on a suitable blockchain, thereby enhancing transparency and trust. The Orchestrator 810 also provides capabilities for managing member roles, assigning granular permissions based on these roles, and maintaining or integrating with systems that track member reputation scores within the ensemble, which can influence participation levels and trust.

Another responsibility of the federated ensemble orchestrator 810 is distributed workflow management. This capability enables ensembles to define, initiate, and manage the execution of complex and multi-stage workflows that inherently span multiple participating members and their respective systems. Effective distributed workflow management includes several main operational aspects. First, it involves task decomposition, where a broader collaborative objective is broken down into smaller, more manageable sub-tasks, followed by the intelligent assignment of these tasks to appropriate members based on their capabilities, roles, permissions, or declared willingness to participate. Second, the orchestrator 810 manages the coordination of data contributions from various members. This is a sensitive operation, often involving the secure submission of encrypted data, partially computed results, or cryptographic attestations such as zero-knowledge proofs, all orchestrated to ensure that data is provided at the right stage of the correct workflow and in the correct format. Finally, after individual members have completed their assigned tasks or contributed their data, the orchestrator 810 facilitates the aggregation of results from these distributed computations, compiling the partial results into a coherent and meaningful final outcome for the ensemble, which may then be subject to consensus verification as described subsequently.

Finally, the federated ensemble orchestrator 810 is equipped with capabilities for dynamic resource allocation. This function enables the EEM 800 to intelligently and dynamically allocate the necessary computational or data resources from the pool of participating ensemble members. Such allocation decisions are typically based on the specific requirements of the tasks underway within a distributed workflow, the declared or assessed capabilities of individual members, and any pre-existing agreements or policies governing resource contribution and utilization within the ensemble. This ensures that resources are used efficiently and effectively to meet the collaborative objectives of the ensemble.

### Privacy Architecture and Secure Computation Layer

The privacy architecture and secure computation layer 820 is an integral part of the EEM 800, providing the essential cryptographic tools and protocols that ensure collaborations within any ensemble remain privacy-preserving. This layer 820 achieves its objectives by heavily leveraging the capabilities of the enhanced privacy-preserving computation engine 400, whose aspects are illustrated in FIG. 3. A primary function of this layer 820 is its deep integration with the Privacy Engine 400. Specifically, the EEM 800 directly utilizes the Privacy Engine 400 to access and orchestrate a range of advanced privacy-enhancing technologies. These include, but are not limited to, secure multi-party computation (SMPC) protocols, homomorphic encryption (HE) schemes, and zero-knowledge proofs (ZKPs). For example, in a typical operational scenario, ensemble members might contribute data that has been homomorphically encrypted; the Privacy Engine 400, which can be instantiated in a distributed manner on nodes provided by trusted members or dedicated infrastructures, then performs the necessary computations directly on this encrypted data, ensuring that the sensitive underlying information is never exposed, not even during processing.

Furthermore, the privacy architecture and secure computation layer 820 promotes the use of secure data enclaves. This approach may encourage, or in certain high-assurance scenarios, require ensemble members to perform computations on their sensitive local data within hardware-based trusted execution environments (TEEs), such as those provided by technologies like Intel Software Guard Extensions (SGX) or AMD Secure Encrypted Virtualization (SEV). By isolating code and data within these secure enclaves, the system aims to protect sensitive information not only from external threats but also from the underlying host operating system or hypervisor during the local processing phases of a distributed workflow. This provides an additional layer of defense, ensuring that data remains confidential even while being actively processed on a infrastructure of the member.

To further strengthen privacy, particularly when dealing with outputs derived from collective data, the privacy architecture and secure computation layer 820 incorporates differential privacy for aggregated results. When ensemble activities involve the generation of aggregate statistics, analytical insights, or machine learning models based on the combined data contributions of multiple members, differential privacy techniques are systematically applied. These techniques, orchestrated and implemented through the capabilities of the Privacy Engine 400, introduce a carefully calibrated amount of statistical noise or other forms of data obfuscation. This process is designed to prevent the leakage of specific information or contributions from any single member when the aggregated results are shared or used, thereby ensuring that participation in the ensemble does not inadvertently compromise the confidentiality of any single member's underlying data.

### Privacy-Preserving Consensus Engine

The privacy-preserving consensus engine 830 plays a role within the EEM 800 by enabling ensemble members to collectively agree on the state or result of distributed computations, or the validity of shared data, notably without requiring full transparency or exposure of all underlying sensitive data. A mechanism through which this is achieved involves the use of verifiable claims and attestations. In this model, individual members can present cryptographic attestations or formal mathematical proofs, such as Zero-Knowledge Proofs (ZKPs), regarding their data, the computations they have performed, or the assertions they wish to make. The consensus engine 830 is then responsible for the programmatic verification of these presented proofs and, upon successful verification, for establishing a collective, cryptographically secured agreement among ensemble members regarding the validity of these claims or attestations. This process ensures that agreement can be reached based on proven assertions rather than on direct data inspection.

For scenarios requiring high levels of assurance and verifiability, the privacy-preserving consensus engine 830 supports blockchain-based consensus, which, although optional, is often a preferred implementation. In this mode, verified consensus results, such as validated attestations, the confirmed results of federated computations, or other significant ensemble agreements, can be securely anchored to one or more distributed ledgers or blockchains. This anchoring is facilitated through the blockchain-agnostic infrastructure (BAI) 700, whose integral role in connecting various system components to different blockchain networks is depicted in the overall system architecture shown in FIG. 1. Utilizing the BAI 700 to record these consensus results on a blockchain provides an immutable, transparent, and tamper-proof record of all ensemble decisions and agreements, significantly enhancing trust and accountability among members. Furthermore, within this blockchain-based consensus framework, smart contracts can be strategically employed to automate the consensus logic itself and to enforce the ensemble's operational rules and policies. These self-executing contracts can manage aspects such as conditions for agreement, the distribution of rewards or penalties based on participation, and the transparent execution of governance protocols, thereby reducing the need for manual intervention and increasing the efficiency and reliability of the consensus process.

Recognizing that not all ensemble interactions require the robustness or potential overhead of full blockchain-based consensus, the privacy-preserving consensus engine 830 also provides for the use of lightweight consensus protocols. These protocols are particularly suitable for less decisions, more frequent interactions, or scenarios where rapid agreement is prioritized over absolute immutability. Such lightweight mechanisms are typically tailored for federated environments and may include optimized voting schemes, gossip protocols, or other forms of distributed agreement that offer lower latency and computational cost, while still providing a sufficient degree of consensus for the specific needs of the ensemble task. The choice of consensus mechanism can thus be adapted by the ensemble based on the specific security, speed, and verifiability requirements of each interaction.

### Interoperability Framework

Recognizing that members of a collaborative ensemble likely employ a wide range of diverse IT systems, proprietary data formats, and distinct operational protocols, the interoperability framework 840 is established as a component of the EEM 800 to ensure effective collaboration. This framework 840 directly addresses the challenges posed by such heterogeneity. An aspect of this framework is data standardization and transformation. This involves providing a suite of tools and services designed to transform data from the native formats used by individual members into a common canonical model understood by the ensemble, or alternatively, to enable secure comparison and computation directly across these heterogeneous data representations. Such processes may incorporate techniques such as semantic mapping, which defines relationships between different data schemas, and ontology alignment, which reconciles differing conceptual models, thereby creating a shared understanding and a coherent data foundation for collaborative activities.

To further facilitate integration, the Interoperability Framework 840 includes an API Gateway and a system of adapters. The API Gateway offers a set of well-defined and standardized Application Programming Interfaces (APIs) that ensemble members can use to connect their disparate IT systems to the Enhanced Ensemble Management (EEM) 800 platform. This standardized interface simplifies the process of establishing communication and data exchange pathways. To complement the gateway, adapters specific to common enterprise systems can be developed and deployed, such as Customer Relationship Management (CRM) platforms, existing fraud detection systems, or other legacy or specialized software. These adapters act as translators, bridging the gap between the EEM's standardized APIs and the native interfaces of members' internal systems, thereby simplifying the integration effort and reducing the technical burden for participating organizations.

Finally, the interoperability framework 840 supports cross-system workflow integration. This capability is essential for dynamic collaborative processes, as it allows the Enhanced Ensemble Management (EEM) 800 platform to actively trigger actions or retrieve necessary data from the internal IT systems of participating members as integral stages within a distributed workflow. Such cross-system interactions are governed by agreed-upon permissions, data sharing policies, and robust security protocols established by the ensemble. This ensures that while the EEM 800 can orchestrate complex workflows that span organizational boundaries, it does so in a manner that respects the data sovereignty and security requirements of each member, enabling automated yet controlled interactions between the central EEM platform and the members' distributed systems.

### Trust and Reputation Management

To ensure the ongoing reliability and promote the sustained integrity of the collaborative ensemble, a dedicated trust and reputation management system 850 is incorporated as a component of the EEM 800. This system 850 employs several mechanisms to build and maintain a trustworthy operational environment. An aspect of this system is behavioral monitoring. This involves the continuous and systematic observation of the activities of members within the ensemble, focusing specifically on their interactions, data contributions, and overall compliance with the established ensemble rules, governance policies, and operational protocols. Such monitoring provides the foundational data necessary to assess member conduct and adherence to agreed-upon standards.

Building upon data collected through behavioral monitoring, the trust and reputation management system 850 implements a reputation scoring mechanism. This involves the assignment of quantifiable reputation scores to each ensemble member. These scores are dynamically calculated and updated based on a variety of factors, including their historical behavior within the ensemble, the verifiable reliability and quality of their data contributions, their consistency in adhering to established operational policies and governance rules, and their responsiveness in collaborative tasks. Such reputation scores serve as an indicator of trustworthiness and can be used to influence a privileges of the member within the ensemble, their ability to participate in certain sensitive workflows, or even their weight and influence in consensus mechanisms, thereby incentivizing positive and reliable contributions.

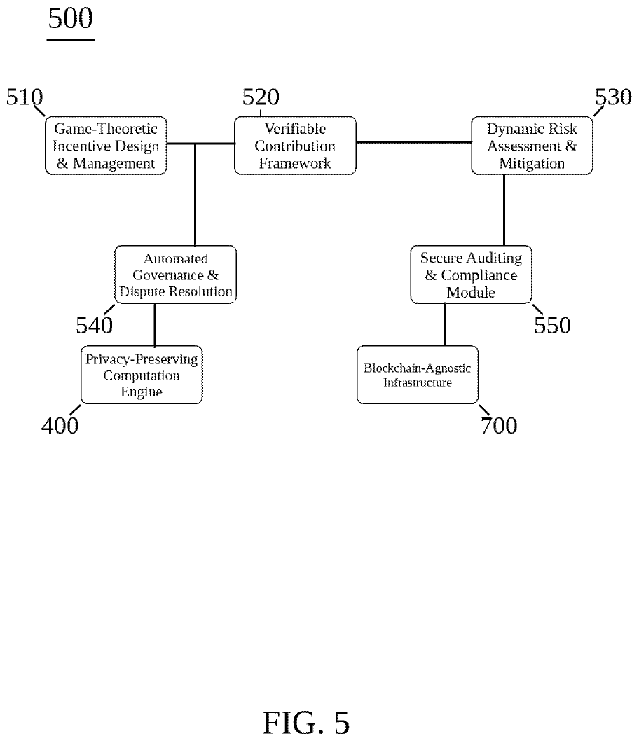

Complementing behavioral monitoring and reputation scoring, the trust and reputation management system 850 also comprises incentive mechanisms designed to proactively encourage desirable conduct. These mechanisms may incorporate game theory-based incentive structures, which mathematically model interactions to promote honest participation and the contribution of high-quality, reliable data by all members. In implementations where the EEM 800 is integrated with a blockchain via the BAI 700, these incentives can be token-based, enabling transparent and automated distribution of rewards for positive contributions or penalties for harmful actions. The design and implementation of such robust incentive structures are closely aligned with, and may leverage aspects of, the Provably Robust Ensemble Management (PREM) 500, whose detailed architecture and game theory-based security foundations are further elucidated in the context of FIG. 5. By aligning incentives with the overall objectives of the ensemble, this system 850 reinforces trust and enhances the collective integrity and performance of the EEM 800.

### Operational Example: Federated Fraud Detection

To illustrate the practical application of the Enhanced Ensemble Management (EEM) 800 and its components, consider an operational example involving federated fraud detection. In this scenario, a consortium of financial institutions decides to form an ensemble, leveraging the EEM 800, with the shared objective of collaboratively detecting cross-institutional fraudulent transaction patterns that might be invisible to any single entity. The process begins with ensemble formation, in which the federated ensemble orchestrator 810 is used to define the consortium's membership criteria, onboard participating institutions, and establish the governance rules, data sharing agreements, and operational policies that will govern their collaboration. Once the ensemble is established, the next phase involves privacy-preserving data contribution. Each member institution, using the capabilities of the privacy architecture and secure computation layer 820 in conjunction with the enhanced privacy-preserving computation engine 400, prepares its local transaction data. This preparation typically involves encrypting the data (e.g., using Homomorphic Encryption) or transforming it into privacy-preserving representations, such as generating Zero-Knowledge Proofs (ZKPs) related to specific transaction patterns or characteristics, ensuring that sensitive raw data is not shared directly. After data preparation, the federated ensemble orchestrator 810 coordinates a distributed analysis task. This might involve, for example, training a global federated machine learning model for fraud detection using the transformed data from all members, or executing a secure multi-party computation (SMPC) protocol to identify common suspicious entities or transaction links that appear across multiple institutions' datasets. Throughout this distributed analysis, the privacy of each institution's proprietary data is maintained. Finally, upon completion of the analysis, the privacy-preserving consensus engine 830 is employed to enable all member institutions to securely and verifiably agree on the collective results. These might be the parameters of the jointly trained fraud detection model, a list of newly identified high-risk entities, or other actionable insights. Importantly, this consensus is reached without any institution having to reveal its raw transaction data to others. For enhanced verifiability and immutability, these validated results can then be anchored on a shared distributed ledger via the Blockchain-Agnostic Infrastructure (BAI) 700, providing a reliable record of the findings of the ensemble. Subsequently, each participating institution receives these actionable insights. The collective intelligence derived from the ensemble's federated analysis is typically far more comprehensive than what any single institution could derive from its data in isolation. These enriched insights enable them to significantly improve their local fraud detection systems and strategies. Throughout this collaborative process, the trust and reputation management system 850 plays a continuous role by monitoring participation, ensuring equitable contribution from all members, and discouraging behaviors such as free-riding, thereby maintaining the health and effectiveness of the ensemble.

The Enhanced Ensemble Management 800 component thus enables organizations to collaborate securely and effectively, unlocking collective intelligence while protecting data privacy and sovereignty.

### Provably Robust Ensemble Management

According to an embodiment of the present disclosure, building upon the foundation of the Enhanced Ensemble Management (EEM) 800, the Trustless Positive Identification system further incorporates a Provably Robust Ensemble Management 500 component (hereinafter “PREM”). The PREM 500 differs from conventional ensemble management by introducing mechanisms to ensure security, fairness, and resilience against adversarial behavior. Prior art often lacks robust defenses against strategic manipulation or non-cooperation within federated systems. The utility of the PREM 500 lies in its ability to create a trustworthy ecosystem through game theory-based incentive design, verifiable contribution frameworks, automated dispute resolution, and comprehensive risk assessment. This integration of advanced cryptographic and economic principles is a solution that significantly enhances the reliability and integrity of collaborative data operations, particularly in environments with potentially untrusted participants. Its primary purpose is to ensure that ensemble operations remain reliable and trustworthy even in the presence of potentially adversarial, selfish, or non-cooperative members, thereby fostering a more robust ecosystem for federated identity verification and data sharing. The PREM 500 is also referred to herein as a game-theory-based ensemble management system or an ensemble management system.

The Provably Robust Ensemble Management 500 system operates within the broader context of the overall system architecture, generally represented in FIG. 1, and its specific architecture is detailed in FIG. 5. The PREM 500 integrates with and extends the functionality of the EEM 800.

As shown in FIG. 5, the provably robust ensemble management system 500 comprises a game-theoretic incentive design and management component 510, a verifiable contribution framework 520, and a dynamic risk assessment and mitigation component 530, together with an automated governance and dispute resolution component 540 and a secure auditing and compliance module 550, and operates in conjunction with the privacy-preserving computation engine 400 and the blockchain-agnostic infrastructure 700.

### Game Theory-Based Incentive Design with Verifiable Contributions and Automated Dispute Resolution

The preferred implementation mode of the PREM 500 involves a synergistic combination of several main strategies. First, it incorporates game-theoretic incentive mechanisms 510, which focus on designing explicit rules, rewards, and penalties structured to align the individual interests of ensemble members with the overall objectives and sustained health of the ensemble. Second, it establishes a verifiable contribution framework 520, an element that obliges members to provide cryptographic proofs of their contributions, whether data, computational effort, or adherence to compliance protocols, thereby ensuring solid accountability, preventing instances of free-riding, and discouraging the submission of low-quality or malicious inputs. Third, the PREM 500 integrates dynamic risk assessment and mitigation 530 capabilities, enabling continuous evaluation of potential threats and member behaviors to proactively adjust security postures and incentives. Finally, it leverages automated governance and dispute resolution 540, which employs smart contracts and algorithmic decision-making processes to enforce ensemble rules and resolve conflicts transparently and efficiently.

The concept is to create a self-regulating and self-healing ensemble environment where rational members are incentivized to act honestly and cooperatively, and where deviations can be detected, proven, and penalized, thereby ensuring the long-term viability and reliability of the ensemble.

### Main Architectural Components and Operational Principles

The PREM 500 enhances the EEM 800 through the following specialized components:

### Game-Theoretic Incentive Design and Management

The game-theoretic incentive design & management 510 component is primarily responsible for the creation and ongoing management of the economic and reputational incentives that govern interactions within the ensemble. An aspect of this component 510 is incentive modeling. This involves the application of established game theory principles, such as mechanism design and contract theory, to accurately model the interactions among ensemble members and to design incentive schemes. These schemes are specifically engineered to promote desirable behaviors, including, but not limited to, the timely and accurate provision of data, active participation in consensus mechanisms, and strict adherence to agreed-upon privacy protocols. Furthermore, the component 510 defines robust mechanisms for reward distribution. These mechanisms delineate how rewards, which may take various forms such as monetary compensation, token-based incentives distributed via a blockchain (leveraging the Blockchain-Agnostic Infrastructure (BAI) 700 as contextualized in the overall system architecture of FIG. 1), or reputation score enhancements, are allocated to members who make positive contributions to the ensemble. Such rewards are typically designed to be proportional to the assessed value or quality of the contribution, as verified by the verifiable contribution framework 520. Complementing the reward system, the component 510 also implements penalty (slashing) mechanisms. These are designed to impose disincentives for undesirable behaviors, which may include the submission of false or misleading data, failure to participate in ensemble activities, attempts to compromise system integrity, or violations of privacy agreements. Applied penalties may range from financial losses (e.g., forfeiture of staked tokens), to reputation reduction, or, in the most severe cases, expulsion from the ensemble. Finally, to ensure the ongoing effectiveness and relevance of the incentive structures, component 510 supports dynamic incentive adjustment. This allows incentives to be dynamically modified by the system, potentially guided by AI-based analysis or through formal ensemble governance votes. Such adjustments are typically based on the current operational state of the ensemble, observed member behaviors, and the evolving strategic objectives of the collaboration.

### Verifiable Contribution Framework

The verifiable contribution framework 520 is relevant to ensuring that all contributions offered by ensemble members are genuine, accurate, and consistently meet predefined quality standards. A central principle of this framework 520 is the mandatory use of cryptographic proofs of contribution. Members are required to accompany their data submissions or computational contributions with robust cryptographic proofs that substantiate the validity and integrity of their input. Examples of such proofs are multifaceted and may include Zero-Knowledge Proofs (ZKPs), which allow members to prove specific properties or characteristics of their data (e.g., asserting “I possess data that matches criteria X”) without requiring the direct revelation of the sensitive underlying data itself. Another form includes proofs of computation, which serve to cryptographically verify that a particular computation was performed correctly and according to specified algorithms; this is often achieved using advanced cryptographic constructions such as zk-SNARKs or zk-STARKs, particularly pertinent for outsourced or complex computations.

Furthermore, members may provide signed attestations, which are digitally signed statements that vouch for data accuracy or confirm adherence to established ensemble protocols. Beyond cryptographic verification, the framework 520 also incorporates comprehensive data quality validation mechanisms. These typically involve automated checks designed to validate the intrinsic quality, consistency, and contextual relevance of any contributed data, potentially employing AI-based anomaly detection techniques to identify and flag suspicious submissions. Notably, to ensure that these verification processes themselves do not compromise confidentiality, the verifiable contribution framework 520 maintains a deep integration with the enhanced privacy-preserving computation engine 400 (also referred to as the Privacy Engine, detailed in relation to FIG. 3). This integration enables the framework 520 to leverage the advanced capabilities of the Privacy Engine 400, allowing the necessary verifications and validations to take place in a strictly privacy-preserving manner, thereby safeguarding sensitive information throughout the entire contribution and verification lifecycle.

### Dynamic Risk Assessment and Mitigation Engine

The dynamic risk assessment and mitigation engine 530 serves as a vigilant guardian within the PREM 500, continuously monitoring the ensemble for emerging risks and dynamically adapting defensive postures accordingly. A function of this engine 530 is behavioral analysis and threat detection. The dynamic risk assessment and mitigation engine 530 is also referred to herein as a dynamic risk assessment system.

To achieve this, it employs advanced analytics machine learning algorithms to monitor the activities of all ensemble members. This enables the identification of suspicious behavioral patterns, the early detection of potential attacks, such as collusion among members, Sybil attacks attempting to gain disproportionate influence, or data poisoning attempts aimed at corrupting shared models or datasets, and the overall assessment of the ensemble's threat landscape. Based on the continuously updated risk levels assessed through this behavioral analysis, the engine 530 is authorized to activate adaptive security policies. These policies enable a range of dynamic and proportionate responses. For example, the engine 530 can automatically increase the level of scrutiny or intensify verification requirements for members identified as high-risk. In more severe cases, it can temporarily isolate suspicious members from ensemble operations to prevent potential harm. Furthermore, it can adjust incentive parameters within the game-theoretic incentive design & management 510 component to actively disincentivize risky or non-compliant behaviors, and can also recommend specific modifications to the ensemble's governance rules to address newly identified vulnerabilities or threat vectors. Complementing its reactive capabilities, the engine 530 also engages in predictive risk modeling. This proactive function aims to forecast future risks by analyzing historical data, recognizing evolving patterns, and considering current trends both within the ensemble and in the broader threat environment. Such predictive modeling enables the PREM 500 to develop and implement proactive mitigation strategies, thereby enhancing the ensemble's resilience against anticipated threats before they can fully materialize.

As a worked example of the incentive mechanics of the PREM 500, the game-theoretic incentive design and management 510 component aligns the behavior of participants in a collaborative federation with one or more objectives of the federation by associating contributions of a participant with one or more rewards and associating non-cooperative or harmful behavior, such as non-participation, collusion, or data poisoning, with one or more penalties. Contributions are verified by the verifiable contribution framework 520 using cryptographic proofs and blockchain attestations before a reward is allocated, the dynamic risk assessment and mitigation engine 530 adjusts one or more incentive parameters of the component 510 in response to a detected risk so as to disincentivize risky or non-compliant behavior, and the resulting rewards and penalties are distributed and enforced through one or more self-executing smart contracts of the automated governance and dispute resolution 540 component.

### Automated Governance and Dispute Resolution

The automated governance and dispute resolution 540 component plays a role in automating the enforcement of established ensemble rules and in providing robust mechanisms for resolving any disputes that may arise in a fair, efficient, and transparent manner. A significant aspect of this automation is achieved through smart contract-based governance. In this preferred approach, many of the governance rules, such as those relating to voting mechanisms for collective decision-making, the logic for reward distribution, and the protocols for penalty enforcement, are codified as self-executing smart contracts. These smart contracts are typically deployed on a blockchain chosen through the Blockchain-Agnostic Infrastructure (BAI) 700, which is a main part of the overall system architecture illustrated in FIG. 1. This governance method ensures that rules are executed transparently and are resistant to tampering, fostering a high degree of trust and predictability within the ensemble. In situations where disputes inevitably arise, such as contested penalties or disagreements over data interpretation, the PREM 500 implements algorithmic dispute resolution processes. These processes can be fully algorithmic or semi-algorithmic, designed to handle conflicts systematically. Such a process might involve several stages, including automated evidence collection, where relevant data such as system logs and cryptographic proofs are gathered and presented. Depending on the nature and severity of the dispute, the process may allow escalation to a designated panel of arbiters. These arbiters might be other reputable ensemble members known for their impartiality, or specifically chosen third parties with relevant expertise, potentially selected through a random or expertise-based mechanism. The resolution process itself often incorporates formal voting mechanisms, with the final outcomes being programmatically enforced by smart contracts to ensure binding and impartial decisions. To maintain accountability and support review, all governance actions, risk assessments undertaken by the dynamic risk assessment and mitigation engine 530, and dispute resolution outcomes are recorded, creating transparent audit trails. These trails are preferably recorded immutably, for example, on a blockchain via the BAI 700, providing a comprehensive and verifiable history of all governance-related activities within the ensemble.

### Secure Auditing and Compliance Module

The secure auditing and compliance module 550 is designed to facilitate comprehensive auditing of all ensemble activities, primarily to ensure adherence to compliance mandates and to uphold security standards, all while maintaining the privacy of sensitive data. This module provides regulatory compliance support by offering a suite of tools and generating detailed reports that assist ensemble members in demonstrating their compliance with a wide range of relevant regulations, such as the General Data Protection Regulation (GDPR), the Health Insurance Portability and Accountability Act (HIPAA), or other industry-specific standards that may apply to their operations. Furthermore, the module enables privacy-preserving audits, allowing authorized auditors to effectively verify compliance status or investigate incidents without requiring direct access to sensitive raw data. Such privacy-preserving audits are conducted using advanced cryptographic techniques, such as homomorphic encryption schemes or Zero-Knowledge Proofs (ZKPs), which depend heavily on, and are deeply integrated with, the capabilities of the enhanced privacy-preserving computation engine 400 (also referred to as the Privacy Engine, detailed in relation to FIG. 3). Additionally, the module ensures the creation of immutable logs for forensics, which involves the immutable recording of all system events and significant member actions. Preferably, these logs are recorded on a blockchain ledger through the Blockchain-Agnostic Infrastructure (BAI) 700, as contextualized in the overall system architecture represented in FIG. 1, thereby providing a tamper-proof and verifiable record that can be relevant for post-incident analysis and resolution.

### Operational Example: Ensuring Fair Contribution to a Federated AI Model

Consider an operational example in which an ensemble collaborates to train a federated machine learning model, similar to the scenario described for the Enhanced Ensemble Management (EEM) 800, but now specifically enhanced with the capabilities of the Provably Robust Ensemble Management (PREM) 500. The process unfolds in several stages.

Initially, an incentive setup 510 phase occurs, in which the ensemble explicitly defines the reward structure. Members are rewarded based on both the quality and quantity of their data contributions, as well as the measurable improvement that their specific data brings to the global federated model. Simultaneously, penalties for harmful actions are clearly defined, such as the submission of intentionally misleading or corruptive data.

Subsequently, the process emphasizes verifiable contributions 520. When a member submits model updates, for example gradients in a federated learning context, they are obligated to accompany these updates with a Zero-Knowledge Proof (ZKP). This ZKP serves to demonstrate that their update was correctly computed based on their local data and, notably, that their local data adheres to certain predefined quality criteria, such as minimum size or appropriate feature distribution. This step ensures the integrity and utility of individual contributions.

Subsequently, risk assessment 530 is continuously performed by the PREM 500. The system actively monitors all submitted updates. If a member consistently submits updates that degrade the global performance of the model or exhibit anomalous characteristics, their internal risk score is increased. An elevated risk score could trigger more stringent verification requirements for their future contributions or lead to a reduction in their influence within the ensemble or in the rewards to which they are entitled.

After each training round, reward/penalty adjudication takes place (using 510 and 540). Rewards are calculated based on each member's verified contributions and their assessed positive impact on the model. If a member is penalized, for example, due to submitting poor-quality updates, and chooses to contest this penalty, the automated governance and dispute resolution 540 mechanism is invoked. In this process, all pertinent evidence, including cryptographic proofs and performance metrics, is thoroughly examined, potentially by an automated system or a designated arbitration committee. The final decision resulting from this dispute resolution is then enforced programmatically, often via a smart contract to ensure impartiality and compliance.

Finally, secure auditing 550 is conducted periodically. An authorized auditor can verify that the entire reward and penalty system is operating fairly and in compliance with the specified rules. This audit is performed using privacy-preserving techniques, such as those provided by the enhanced privacy-preserving computation engine 400 (as detailed in relation to FIG. 3), allowing the auditor to examine the operational process without gaining access to members' raw data or their specific model updates, thereby maintaining confidentiality.

The Provably Robust Ensemble Management 500 system, by integrating these game theory-based and cryptographic safeguards, significantly enhances the reliability and operational resilience of federated collaborations, making the Trustless Positive Identification system more robust against both internal and external threats.

### Ensemble Identifier System

The present disclosure includes an ensemble identifier system that provides data integrity, controlled disclosure, and verifiable provenance for ensembles of identity data. According to an embodiment of the present disclosure, the ensemble identifier system includes a master hash generator that creates individual cryptographic hashes for the data components of an ensemble, combines the individual hashes into a master hash list in the manner of a BitTorrent-style hash list, and generates a master hash from the master hash list for data integrity verification.

A commit-reveal module combines the master hash with a user-controlled secret, such as a password or a randomly generated nonce, and creates a cryptographic hash of the combination as a commit value. The commit value is stored on a blockchain while a reveal value is kept hidden, thereby protecting the secret while enabling third-party verification and selective disclosure through later revelation of the secret without compromising future security. A data-retrieval module establishes a cryptographic binding between data and blockchain identifiers by associating anonymized data with one or more uniform resource identifiers (URIs), creating retrieval identifiers by combining file references and their hashes, and storing the cryptographic binding on the blockchain, thereby enabling data retrieval and integrity verification through URI-hash pairs. The reveal value comprises the combination of the master hash and the user-controlled secret.

A temporal proof module records ensemble identifiers on the blockchain with immutable timestamps, establishing a provable data-acquisition time, preventing retroactive falsification through distributed-ledger consensus, and enabling chronological verification of data existence and status.

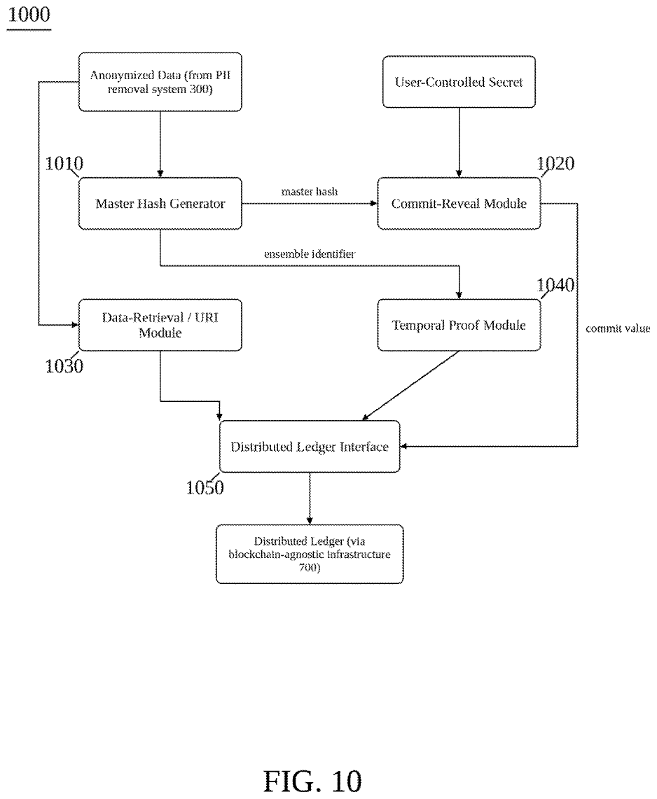

Referring to FIG. 10, the ensemble identifier system 1000 comprises a master hash generator 1010, a commit-reveal module 1020, a data-retrieval module 1030, a temporal proof module 1040, and a distributed ledger interface 1050. The master hash generator 1010 creates the individual cryptographic hashes for the data components of an ensemble that includes the anonymized data, combines the individual cryptographic hashes into a master hash list, and generates the master hash from the master hash list. The commit-reveal module 1020 generates the commit value by cryptographically hashing the combination of the master hash and the user-controlled secret, the combination constituting the reveal value that is kept hidden from the distributed ledger. The data-retrieval module 1030 associates the anonymized data with a uniform resource identifier (URI) and creates a retrieval identifier that combines a file reference and a hash of the referenced file. The temporal proof module 1040 records an ensemble identifier on the distributed ledger with an immutable timestamp that establishes a provable data-acquisition time. The distributed ledger interface 1050 records the commit value, the retrieval identifier, and the temporal proof on the distributed ledger through the Blockchain-Agnostic Infrastructure 700.

Because a distributed ledger provides an immutable and tamper-evident record, the ensemble identifier system 1000 anchors to the distributed ledger only privacy-preserving representations, such as hashes, commit values, attestations, and zero-knowledge proofs, rather than raw biometric data or personally identifiable information, thereby obtaining the integrity and provenance benefits of immutability without recording sensitive data of the user on a medium that cannot later be erased.

### Advanced Data Custodian Interface

According to an embodiment of the present disclosure, the Trustless Positive Identification system further includes an Enhanced Data Custodian Interface 600 (hereinafter “EDCI”). The EDCI 600 differs from traditional data access portals or basic anonymization techniques found in prior art. It provides a suite of tools and governance mechanisms, including a privacy-preserving analytics platform with differential privacy, secure multi-party computation, privacy-preserving machine learning, a regulatory compliance interface, and synthetic data generation capabilities. The utility of the EDCI 600 is to enable organizations (data custodians) to derive valuable insights and conduct complex analyses on sensitive identity-related data, while maintaining individual privacy and ensuring regulatory compliance. This approach of providing a secure, controlled, and feature-rich environment for privacy-preserving secondary data use is a solution that balances the need for data utility with stringent data protection mandates. It ensures that data custodians cannot link anonymized data to specific individuals and maintains transparent accountability for all data access and use. The EDCI 600 is also referred to herein as a privacy-preserving data custodian interface.

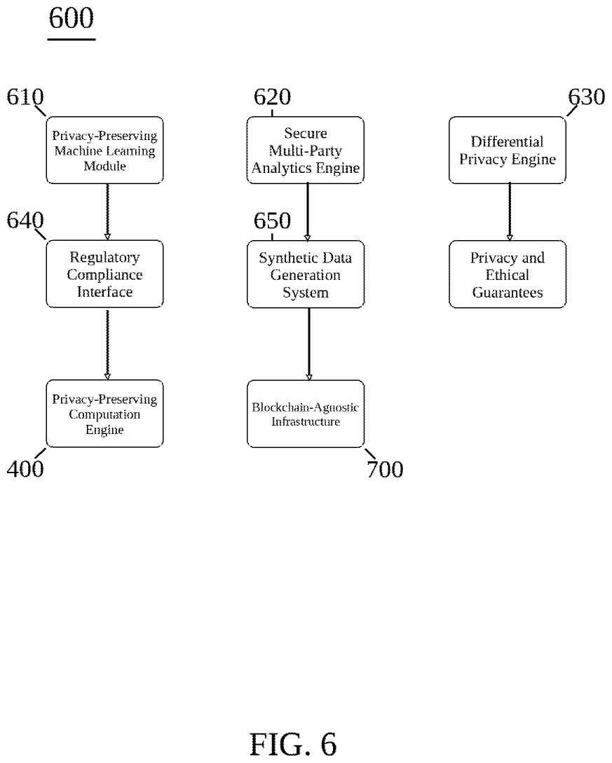

The Enhanced Data Custodian Interface 600, whose role in the overall system is generally represented in FIG. 1 and whose detailed architecture is illustrated in FIG. 6, integrates several advanced privacy-enhancing technologies and governance frameworks.

As shown in FIG. 6, the data custodian interface 600 comprises a privacy-preserving machine learning module 610, a secure multi-party analytics engine 620, and a differential privacy engine 630, together with a regulatory compliance interface 640 and a synthetic data generation system 650, and operates in conjunction with the privacy-preserving computation engine 400 and the blockchain-agnostic infrastructure 700.

### Privacy-Preserving Analytics Platform

The preferred implementation mode of the EDCI 600 focuses on a privacy-preserving analytics platform. This platform enables organizations to perform valuable analyses on sensitive data with strong, often mathematical, guarantees that individual privacy remains protected. It acts as a privacy guardian by controlling information exposure, strategically adding protective noise where necessary, tracking cumulative privacy impact, and enforcing predefined privacy thresholds.

The operational flow typically involves a data custodian submitting an analysis request. The platform then verifies the request against a privacy budget, performs the analysis using protected methods, ensures that privacy guarantees are met, and finally delivers the aggregated or anonymized results.

The privacy-preserving analytics platform comprises several main engines: The privacy-preserving analytics platform includes the privacy-preserving machine learning module 610, which enables machine learning on encrypted data.

### Differential Privacy Engine

The differential privacy engine 630, also referred to as a differential privacy toolkit, serves as a component within the privacy-preserving analytics platform, specifically designed to provide robust and quantifiable privacy guarantees for data analysis. Its operation is characterized by several main functionalities.

A primary function is careful privacy budget management. The engine 630 carefully measures and allocates a finite “privacy budget” for each dataset under its supervision. Each analytical query or computational activity performed on the dataset consumes a predetermined portion of this budget, ensuring that cumulative privacy loss remains within acceptable, predefined limits.

To safeguard individual records contained in a dataset, the engine 630 employs calibrated noise injection. This technique involves the introduction of a precisely calculated amount of statistical noise into query results.

The magnitude of this noise is carefully calibrated: it must be substantial enough to effectively mask the contributions of any single individual within the dataset, thereby preventing their re-identification, but at the same time small enough to preserve the overall accuracy and utility of the aggregate information derived from the analysis.

Furthermore, the differential privacy engine 630 provides strong mathematical guarantees of privacy. Differential privacy itself is a formal mathematical definition, which guarantees that the result of any analysis performed on a dataset remains essentially unchanged, regardless of whether a particular data of the individual is included in or excluded from the input. This intrinsic property offers protection against various privacy threats, including linkage attacks and inferential disclosures.

Finally, the engine 630 enforces rigorous threshold enforcement regarding privacy loss. It maintains strict control over the cumulative privacy budget consumed by successive analyses. In the event that the predefined privacy budget for a dataset is exhausted, or even approached, the engine 630 is designed to automatically halt any further analysis on that dataset, thereby preventing excessive privacy loss and upholding the integrity of the privacy protection mechanisms. The EDCI 600, including this differential privacy engine 630, operates within the broader system architecture generally represented in FIG. 1.

### Secure Multi-Party Analytics Engine

For more complex analytical tasks that require collaboration among multiple entities without the direct sharing of their sensitive raw data, the Secure Multi-Party Analytics Engine 620 is employed within the EDCI 600. This engine 620 operates on the basis of the well-established cryptographic principles of Secure Multi-Party Computation (SMPC).

A characteristic of its operation is distributed computation. Sensitive computations are strategically decomposed and executed across multiple independent and, notably, non-colluding processing parties, or within secure hardware enclaves (such as Intel SGX or AMD SEV). This distribution ensures that the computational workload is shared and, more importantly, that the underlying data is not centralized.

This leads to the principle of no single point of exposure. In an SMPC protocol orchestrated by this engine 620, each participating party typically holds only a cryptographic share or an encrypted segment of the overall data. This architectural design ensures that no single entity, including any individual party or an external observer, can gain access to or reconstruct the complete raw dataset at any point during the computation.

The ultimate objective is collaborative insight generation. The participating parties, through carefully designed cryptographic protocols, collaboratively compute a joint function over their respective private inputs. While the computations intermediate results and individual data shares remain confidential, the final result of the joint function, which could be an aggregate statistic, a parameter for a machine learning model, or another form of combined insight, is revealed to authorized parties. Notably, the individual inputs used to derive this result remain private throughout the process. This capability enables the generation of valuable insights that no single party could have derived solely from their own partial data, fostering data-driven collaboration while maintaining rigorous privacy. The EDCI 600, which incorporates this engine 620, is intended as part of the overall system architecture outlined in FIG. 1.

### Privacy-Preserving Machine Learning Module

This module 610 within the EDCI 600 is dedicated to enabling the training and deployment of advanced Artificial Intelligence (AI) and Machine Learning (ML) models in a manner that protects the sensitive underlying training data. It achieves this through several techniques.

A main approach is federated learning. This paradigm enables ML models to be trained in a decentralized manner on data that remains under the control of different data custodians, residing in their respective secure environments. Instead of aggregating raw data, only the model updates, such as gradients or learned parameters, are shared and aggregated centrally (or in a distributed, privacy-preserving manner) to refine a global model. This ensures that raw training data never leaves the premises of the custodian.

Another technique employed is homomorphic encryption for ML. This advanced cryptographic method enables certain computations, such as model inference or specific training steps, to be performed directly on encrypted data without prior decryption. The remarkable property of homomorphic encryption is that the results of these computations, when finally decrypted, are identical to those that would have been obtained by performing the same operations on plaintext data. This enables the secure outsourcing of ML tasks or the collaborative construction of models on encrypted datasets.

Further enhancing data protection during ML processes, the module 610 supports secure enclave-based ML. With this method, both model training and the execution of inference tasks can take place within hardware-based trusted execution environments (TEEs), commonly referred to as secure enclaves. These enclaves provide strong isolation, protecting the confidentiality and integrity of data and computations even from the host system's operating system or other privileged software.

Beyond protecting the training data itself, the module 610 also focuses on the privacy implications of trained models. It incorporates techniques for model privacy evaluation. These techniques are designed to measure and limit the potential privacy impact of deployed models, ensuring that the predictions or outputs generated by these models cannot be easily exploited to reconstruct or infer sensitive information about the individuals whose data was used in the training set. This addresses concerns related to model inversion attacks or membership inference attacks. The EDCI 600, with this module 610, operates as part of the system illustrated in FIG. 1.

### Regulatory Compliance Interface

A function of the EDCI 600 is ensuring that all data uses adhere to applicable laws, regulations, and ethical guidelines across various jurisdictions. The regulatory compliance interface 640 is specifically designed to automate and accurately document these vital compliance processes.

This interface 640 excels in policy interpretation and enforcement. It possesses the ability to understand and interpret complex regulatory requirements, such as those established by GDPR, CCPA, or HIPAA, as well as the internal data governance policies established by the data custodian. Notably, it enforces these policies by ensuring that data is accessible and used only for explicitly permitted purposes and solely by roles that have been granted appropriate authorization.

Furthermore, the interface 640 performs jurisdictional analysis. It carefully analyzes data access requests in the context of pertinent regional and national privacy laws, paying particular attention to the complexities and requirements associated with cross-border data flows.

Before any data access is granted or an analytical process is initiated, the interface 640 conducts automated compliance verification. This involves executing a series of automated checks to verify that the proposed data use is aligned with all applicable policies and regulatory obligations.

To ensure transparency and accountability, the interface 640 is responsible for the creation and maintenance of auditable records. It generates comprehensive and immutable audit trails detailing all data access requests, the compliance checks performed, any approvals granted, and the details of data usage activities. These records are often securely recorded, for example, by leveraging the capabilities of the Blockchain-Agnostic Infrastructure (BAI) 700, whose architectural context is provided by FIG. 1, to ensure their integrity and resistance to tampering.

### Data Governance Framework

This sub-component, operating within the broader regulatory compliance interface 640, provides the essential tools and functionalities for defining, managing, and enforcing granular data usage policies.

It implements purpose-specific controls, which allow data custodians to precisely define and enforce the specific and legitimate purposes for which data under their administration may be used. For example, policies may establish that certain datasets are admissible only for research purposes, while others might be restricted to statistical reporting, thereby preventing scope creep and unauthorized data applications.

Furthermore, the framework incorporates robust Role-Based Access Control (RBAC) mechanisms. RBAC ensures that only authorized personnel, assigned to appropriate and verified roles within the organization, can request or obtain access to specific types of analyses or datasets. This principle of least privilege minimizes the risk of unauthorized data exposure or misuse.

Additionally, the data governance framework manages time-bound permissions and data retention. It enforces policies regarding the duration for which data access authorizations are granted, ensuring that access expires when it is no longer needed. It also oversees automated data deletion or re-anonymization processes, which are triggered after a specified retention period has elapsed or when the original purpose for data collection and processing has been fulfilled, aligning with the principles of data minimization and storage limitation.

### Cross-Border Data Transfer Manager

This specialized sub-component, also operating within the regulatory compliance interface 640, is dedicated to managing the complex issues associated with transferring or accessing data across different legal jurisdictions.

It performs automated risk assessment, a step in evaluating the potential legal and privacy risks that arise when proposing to transfer or access data from different countries. This assessment considers the various data protection regimes and the potential impacts on data subjects' rights.

Based on this risk assessment, the manager focuses on safeguard implementation. It ensures that all appropriate legal and technical safeguards are verifiably in place before any data is authorized to cross international borders. Such safeguards may include the implementation of Standard Contractual Clauses (SCCs) as required by competent authorities, reliance on formal adequacy decisions where applicable, or the implementation of supplementary Privacy-Enhancing Technologies (PETs) to provide additional layers of protection commensurate with the identified risks.

Furthermore, the cross-border data transfer manager is responsible for documentation of the legal basis. It systematically records the specific legal justification upon which any cross-border data transfer is based, ensuring that a clear and defensible rationale is maintained for compliance and audit purposes.

### Synthetic Data Generation System

To further enhance data utility for analysis while simultaneously minimizing privacy risks, the EDCI 600 incorporates a synthetic data generation system 650. This system 650 is designed to produce statistically representative artificial data. It achieves this by creating artificial datasets that closely mimic the essential statistical properties, underlying patterns, and complex correlations present in the original sensitive dataset. Notably, these synthetic datasets are generated in such a way that they contain no actual individual records, thereby severing the direct link to real persons.

The generation process itself is inherently privacy-preserving. Advanced Artificial Intelligence (AI) models are often employed, particularly techniques such as Generative Adversarial Networks (GANs) or Variational Autoencoders (VAEs). These models can be trained, frequently incorporating differential privacy mechanisms during the training phase, to learn the underlying probability distribution of the real data. Once this distribution has been accurately learned, the models can then generate entirely new synthetic data samples that are drawn from this learned distribution, effectively creating a privacy-enhanced proxy of the original data.

Before synthetic data is made available for use, it undergoes thorough utility verification. The generated synthetic data is evaluated to ensure it maintains sufficient analytical value and fidelity to the original data. This verification confirms that the synthetic dataset can be reliably used for various purposes, such as software testing, training machine learning models (in certain contexts where the direct use of real data is inadmissible or too risky), and conducting exploratory data analyses, all without exposing any actual personal information.

Complementing utility verification, rigorous risk assessment is performed on the synthetic data. This involves stringent testing and analysis aimed at ensuring that the synthetic data cannot be reverse-engineered or otherwise manipulated to link to or re-identify real individuals from the original dataset. This step is relevant for confirming the privacy-preserving integrity of the generated synthetic data.

### Privacy and Ethical Guarantees

The Enhanced Data Custodian Interface (EDCI) 600 is fundamentally built on a solid foundation of strong privacy and ethical commitments, which permeate its design and operational philosophy.

These commitments manifest, first, through mathematically proven protections. Where possible, the privacy guarantees offered by the EDCI 600 are based on formal mathematical frameworks, such as differential privacy which provides quantifiable guarantees against re-identification, or on the rigorous security properties of advanced cryptographic techniques. This approach aims to provide objective and verifiable privacy levels.

Second, the EDCI 600 is designed for legally compliant operations. Automated adherence to relevant data protection laws and regulations, including but not limited to GDPR, CCPA, and HIPAA, is a design principle. The system actively works to ensure that data management practices remain within the boundaries of applicable legal frameworks.

Third, the interface 600 promotes ethically sound data use. It actively promotes a carefully considered balance between enabling valuable data utilization for legitimate purposes, such as research and service improvement, and the imperative of upholding individual privacy rights and broader ethical considerations. This involves a commitment to fairness, accountability, and the avoidance of bias or discriminatory outcomes.

Finally, transparent governance is integral to the operation of the EDCI 600. Clear oversight mechanisms, together with comprehensive and verifiable logs of all data access requests, approvals, and usage activities (often leveraging the BAI 700 for immutable record-keeping as shown in FIG. 1), ensure a high degree of transparency. This transparency is relevant for building trust among data subjects, data custodians, and regulatory bodies.

By providing these comprehensive capabilities, the Enhanced Data Custodian Interface 600 enables responsible uses of identity-related data, promoting trust and ensuring that data custodians can meet their analytical needs while respecting and protecting individual privacy within the Trustless Positive Identification ecosystem.

### Improvements to the Functioning of Computers and Hardware

The systems and methods described herein provide improvements to the functioning of computing systems and associated hardware. By processing raw biometric data into templates within a secure on-device environment and avoiding long-term storage or external transmission of raw biometric data, the system reduces the attack surface of the device and of the overall system. By processing sensitive data and machine-learning models within hardware-based secure enclaves or trusted execution environments, the system protects data and models during inference from a host operating system and other privileged software. By managing cryptographic keys with a hardware security module, the system improves the security of key material. By performing computations directly on encrypted data through homomorphic encryption, secure multi-party computation, and related privacy-enhancing technologies, the system enables a computer to operate on sensitive data without exposing the underlying plaintext, reducing the risk of data breach during computation. By dynamically selecting, through the blockchain-agnostic infrastructure, a distributed ledger based on transaction requirements, cost, security, and performance metrics, the system improves throughput, latency, and operational cost of recording and verifying data across heterogeneous ledgers. Embodiments of the present disclosure further provide an improvement in the field of data communication and in the security of transactions conducted over a network. By exchanging data over secure communication channels with end-to-end encryption, by reducing the amount of sensitive data transmitted through the use of zero-knowledge proofs and computation on encrypted data, and by anchoring transactions and attestations on a distributed ledger with cryptographic integrity and immutable timestamps, the system improves the reliability and the security of data communications and of the transactions conducted between parties. These improvements are rooted in, and directed to, the operation of the underlying computing devices and hardware components.

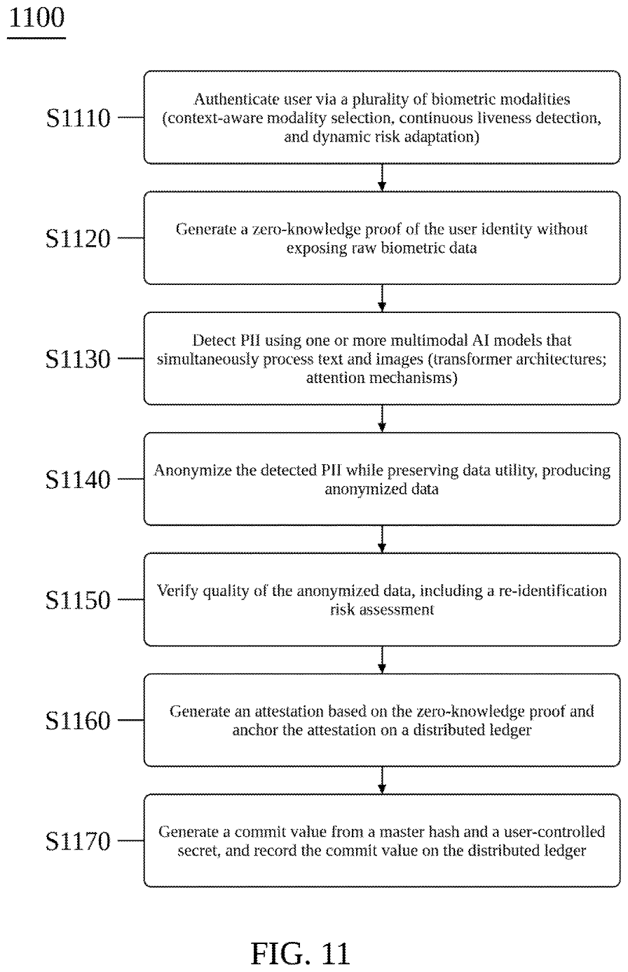

Referring to FIG. 11, a method for positive identification of a user comprises: authenticating an identity of the user from a plurality of biometric modalities, the authenticating including context-aware modality selection, continuous liveness detection, and dynamic risk adaptation (S1110); generating a zero-knowledge proof of the identity of the user without exposing raw biometric data (S1120); detecting personally identifiable information in data associated with the user using one or more multimodal artificial-intelligence models that simultaneously process text and images (S1130); anonymizing the detected personally identifiable information while preserving data utility to produce anonymized data (S1140); verifying quality of the anonymized data, including a re-identification risk assessment (S1150); generating an attestation based on the zero-knowledge proof and anchoring the attestation on a distributed ledger (S1160); and generating a commit value from a master hash and a user-controlled secret and recording the commit value on the distributed ledger (S1170).

1. A positive identification system, comprising:
one or more hardware processors;
one or more biometric sensors configured to capture raw biometric data of a user; and
one or more memories storing instructions that, when executed by the one or more hardware processors, implement:
a multimodal biometric authentication system configured to authenticate an identity of the user based on the raw biometric data, the multimodal biometric authentication system comprising:
a context-aware modality selection module configured to dynamically select, combine, and weight a plurality of biometric modalities based on at least one of a transaction risk level, an environmental condition, or a user preference,
a continuous liveness detection module that, during the biometric authentication of the user, detects a spoofing attempt in real time by analyzing one or more time-varying characteristics of the raw biometric data captured by the one or more biometric sensors over a course of the biometric authentication, a result of the continuous liveness detection module being applied as a condition of authenticating the identity of the user,
a dynamic risk assessment engine configured to adapt one or more authentication requirements of the multimodal biometric authentication system based on contextual and behavioral factors by providing one or more risk inputs to the context-aware modality selection module for selection and weighting of the plurality of biometric modalities for a subsequent biometric capture by the one or more biometric sensors, and
a zero-knowledge proof generator configured to generate a zero-knowledge proof of the identity of the user without exposing the raw biometric data; and
an artificial-intelligence-based personally identifiable information (PII) removal system comprising:
a multimodal PII detection engine comprising one or more multimodal artificial-intelligence models configured to detect PII in data associated with the user by simultaneously processing text and images of the data associated with the user using one or more transformer architectures for contextual PII detection, the multimodal PII detection engine further comprising a cross-modal reasoning module configured to correlate textual mentions with visual appearances across documents,
a context-aware detection module configured to use one or more attention mechanisms to distinguish between benign terms and actual PII, and
an intelligent anonymization module configured to anonymize the PII detected in the data associated with the user, while preserving data utility of the data associated with the user, to produce anonymized data,
wherein the instructions, when executed by the one or more hardware processors, further cause the positive identification system to:
generate an attestation of the identity of the user based on at least the zero-knowledge proof,
anchor the attestation on a distributed ledger,
generate a commit value by cryptographically hashing a combination of a master hash and a user-controlled secret, the master hash being generated from individual cryptographic hashes of data components of an ensemble that includes the anonymized data, the combination constituting a reveal value that is kept hidden from the distributed ledger,
and record the commit value on the distributed ledger, thereby protecting the user-controlled secret while enabling third-party verification of integrity of the anonymized data,
such that the raw biometric data and the PII are not exposed on the distributed ledger.

2. The positive identification system of claim 1, wherein the multimodal biometric authentication system further comprises a data association module configured to link a plurality of biometric templates derived from the raw biometric data to a single user identity of the user and to associate different ones of the biometric templates, or different authentication policies, with different data access levels or transaction types, thereby providing the user with granular control over use of the biometric templates.

3. The positive identification system of claim 1, wherein the context-aware modality selection module is configured to use artificial intelligence to optimize selection of the plurality of biometric modalities based on one or more sensor inputs and an operational context.

4. The positive identification system of claim 1, wherein the artificial-intelligence-based PII removal system is arranged as a multi-stage processing pipeline in which the data associated with the user passes sequentially through an artificial-intelligence-based PII detection stage performed by the multimodal PII detection engine, an intelligent anonymization stage performed by the intelligent anonymization module, and a quality verification stage, wherein the artificial-intelligence-based PII detection stage comprises assigning a confidence score to each detected instance of the PII, and the quality verification stage comprises an automated check confirming that each detected instance of the PII whose assigned confidence score is above a threshold has been anonymized.

5. The positive identification system of claim 1, wherein the multimodal PII detection engine comprises a vision-language model pre-trained on textual and visual data, the vision-language model having cross-modal understanding and reasoning capability and being configured to generate one or more contextual attention maps that identify sensitive entities in the data associated with the user.

6. The positive identification system of claim 1, wherein the intelligent anonymization module is configured to preserve data utility while removing the PII detected in the data associated with the user through synthetic-data substitution and format-preserving masking.

7. The positive identification system of claim 1, further comprising a privacy-preserving computation engine comprising an adaptive privacy controller configured to dynamically optimize a privacy-utility balance using machine learning, wherein the privacy-preserving computation engine is configured to perform a biometric match between an encrypted biometric template derived from the raw biometric data and an encrypted registered biometric template.

8. The positive identification system of claim 7, wherein the adaptive privacy controller is configured to use reinforcement learning to optimize one or more privacy parameters based on system feedback and one or more user requirements.

9. The positive identification system of claim 1, further comprising an ensemble identifier system comprising:
a master hash generator configured to create the individual cryptographic hashes for the data components of the ensemble, to combine the individual cryptographic hashes into a master hash list, and to generate the master hash from the master hash list for integrity verification of the data components;
a commit-reveal module configured to generate the commit value and to enable selective disclosure through revelation of the user-controlled secret;
a data-retrieval module configured to establish a cryptographic binding between the anonymized data and one or more identifiers stored on the distributed ledger by associating the anonymized data with a uniform resource identifier (URI) and creating a retrieval identifier that combines a file reference and a hash of the referenced file, and to store the cryptographic binding on the distributed ledger, thereby enabling retrieval and integrity verification of the anonymized data through the URI and the hash of the referenced file; and
a temporal proof module configured to record an ensemble identifier on the distributed ledger with an immutable timestamp that establishes a provable data-acquisition time.

10. The positive identification system of claim 9, wherein the user-controlled secret comprises at least one of a password or a randomly generated nonce, and wherein the commit-reveal module is configured to use a cryptographic hash function to conceal the master hash and the user-controlled secret until a reveal phase in which the user-controlled secret is revealed.

11. The positive identification system of claim 1, wherein the attestation comprises the zero-knowledge proof or is generated upon verification of the zero-knowledge proof.

12. The positive identification system of claim 1, further comprising a blockchain-agnostic infrastructure comprising:
a blockchain abstraction layer exposing a standardized application programming interface for interaction with a plurality of blockchains;
a plurality of protocol adapters configured to translate calls of the standardized application programming interface into native protocol messages of respective blockchains of the plurality of blockchains; and
a dynamic ledger selection engine configured to select the distributed ledger from among the plurality of blockchains based on at least one of a transaction requirement, a transaction cost, a security requirement, or a performance metric.

13. The positive identification system of claim 1, further comprising a game-theory-based ensemble management system comprising:
a game-theoretic incentive design system configured to align behavior of participants in a collaborative federation with one or more objectives of the collaborative federation through one or more rewards or penalties;
a verifiable contribution framework configured to verify contributions of the participants using cryptographic proofs and blockchain attestations;
a dynamic risk assessment system configured to perform real-time threat modeling and to implement one or more mitigation strategies for the collaborative federation; and
an automated governance and dispute resolution system configured to enforce rules of the collaborative federation through one or more smart contracts.

14. The positive identification system of claim 1, further comprising:
a hardware-based secure enclave configured to protect one or more encryption keys used to encrypt one or more biometric templates derived from the raw biometric data, the one or more biometric templates being processed within a secure on-device environment; and
a hardware security module configured to manage one or more cryptographic keys for signing one or more transactions submitted to the distributed ledger.

15. The positive identification system of claim 1, further comprising a privacy-preserving data custodian interface comprising:
a privacy-preserving analytics platform configured to enable machine learning on encrypted data;
a differential privacy engine configured to provide one or more formal privacy guarantees and privacy-budget management; and
a synthetic data generation system configured to create statistically representative artificial datasets that contain no actual individual records.

16. A method for positive identification of a user, the method being performed by a computing system comprising one or more hardware processors, the method comprising:
authenticating an identity of the user from a plurality of biometric modalities captured via one or more biometric sensors, the authenticating comprising dynamically selecting, combining, and weighting the plurality of biometric modalities based on at least one of a transaction risk level, an environmental condition, or a user preference, performing real-time anti-spoofing liveness detection on biometric data captured via the one or more biometric sensors during the authenticating, and adapting one or more authentication requirements based on contextual and behavioral factors by adjusting the dynamically selecting, combining, and weighting for a subsequent biometric capture via the one or more biometric sensors;
generating a zero-knowledge proof of the identity of the user without exposing raw biometric data of the user;
detecting personally identifiable information (PII) in data associated with the user using one or more multimodal artificial-intelligence models that simultaneously process text and images of the data associated with the user using one or more transformer architectures, the detecting comprising assigning a confidence score to each detected instance of the PII and using one or more attention mechanisms to distinguish between benign terms and actual PII;
anonymizing, based on the assigned confidence scores, at least a subset of the detected instances of the PII, while preserving data utility of the data associated with the user, to produce anonymized data;
verifying quality of the anonymized data, including performing a re-identification risk assessment;
generating, based on at least the zero-knowledge proof, an attestation of the identity of the user;
anchoring the attestation on a distributed ledger;
generating a commit value by cryptographically hashing a combination of a master hash and a user-controlled secret, the master hash being generated from individual cryptographic hashes of data components of an ensemble that includes the anonymized data, the combination constituting a reveal value that is kept hidden from the distributed ledger; and
recording the commit value on the distributed ledger, wherein the raw biometric data of the user and the PII are not exposed on the distributed ledger.

17. The method of claim 16, wherein:
the detecting further comprises flagging, for human review, each detected instance of the PII whose confidence score is below a threshold, and performing contextual validation by cross-referencing PII detected in textual content of the data associated with the user with one or more elements present in visual data of the data associated with the user;
the anonymizing comprises applying, to each detected instance of the PII whose confidence score is above the threshold, an anonymization technique selected based on a PII type, a context in which the detected instance appears, and the confidence score of the detected instance; and
the verifying of the quality of the anonymized data comprises performing an automated check confirming that each detected instance of the PII whose confidence score is above the threshold has been anonymized, performing a data utility test on the anonymized data, and performing the re-identification risk assessment using at least one of a k-anonymity analysis or a simulated re-identification attack.

18. The method of claim 16, further comprising managing an ensemble identifier of the ensemble by:
creating the individual cryptographic hashes for the data components of the ensemble, combining the individual cryptographic hashes into a master hash list, and generating the master hash from the master hash list;
enabling selective disclosure by revealing the user-controlled secret;
establishing a cryptographic binding between the anonymized data and one or more identifiers stored on the distributed ledger by associating the anonymized data with a uniform resource identifier (URI) and creating a retrieval identifier that combines a file reference and a hash of the referenced file, and storing the cryptographic binding on the distributed ledger, thereby enabling retrieval and integrity verification of the anonymized data through the URI and the hash of the referenced file; and
recording the ensemble identifier on the distributed ledger with an immutable timestamp that establishes a provable data-acquisition time.

19. A non-transitory computer-readable medium storing instructions that, when executed by one or more hardware processors of a computing system, cause the computing system to perform operations comprising:
receiving, from a user device, a zero-knowledge proof of an identity of a user, the zero-knowledge proof having been generated at the user device, without exposing raw biometric data of the user, in connection with a biometric authentication performed at the user device, the biometric authentication using a plurality of biometric modalities dynamically selected, combined, and weighted based on at least one of a transaction risk level, an environmental condition, or a user preference, and including real-time anti-spoofing liveness detection;
verifying, by the computing system, the zero-knowledge proof;
detecting personally identifiable information (PII) in data associated with the user using one or more multimodal artificial-intelligence models that simultaneously process text and images of the data associated with the user using one or more transformer architectures, the detecting comprising correlating textual mentions with visual appearances across documents in the data associated with the user, and using one or more attention mechanisms to distinguish between benign terms and actual PII;
anonymizing the detected PII, while preserving data utility of the data associated with the user, to produce anonymized data;
verifying quality of the anonymized data, including performing a re-identification risk assessment;
generating, based on at least the verified zero-knowledge proof, an attestation of the identity of the user;
anchoring the attestation on a distributed ledger;
generating a commit value by cryptographically hashing a combination of a master hash of an ensemble that includes the anonymized data and a user-controlled secret, the combination constituting a reveal value that is kept hidden from the distributed ledger; and
recording the commit value on the distributed ledger,
wherein the raw biometric data of the user and the PII are not exposed on the distributed ledger.
